(19) United States
(12) Patent Application Publication
(10) Pub. No.: US 2025/0045882 A1
(43) Pub. Date: Feb. 6, 2025

(54) ENHANCING DEPTH REPRESENTATIONS BASED ON AMPLITUDES OF TIME-OF-FLIGHT SIGNALS

(71) Applicant: QUALCOMM Incorporated, San Diego, CA (US)

(72) Inventors: Li HONG, San Diego, CA (US); Jing WANG, Saratoga, CA (US); Xiaoyun JIANG, San Diego, CA (US)

(21) Appl. No.: 18/362,703

(22) Filed: Jul. 31, 2023

(51) Int. Cl. G06T 5/00; G01S 17/894; G06T 5/20

(52) U.S. Cl. CPC G06T 5/70; G01S 17/894; G06T 5/20; G06T 2207/10028; G06T 2207/20004

(57) ABSTRACT

Systems and techniques are described herein for enhancing depth representations based on amplitudes of time-of-flight signals. For instance, a computing device can obtain a depth representation of a scene. The depth representation includes depth values based on a time of flight (ToF) signal. The computing device can obtain amplitude values corresponding to the depth values of the depth representation. The amplitude values are based on the ToF signal. The computing device can smooth the depth values based on the depth values and the amplitude values.

### TECHNICAL FIELD

The present disclosure generally relates to enhancing depth representations. For example, aspects of the present disclosure include systems and techniques for enhancing depth representations based on amplitudes of time-of-flight signals.

### BACKGROUND

A direct Time-of-Flight (dToF) depth camera may measure a timing difference (e.g., a time of flight) between when a light pulse is emitted and when the light pulse is received by the dToF depth camera (e.g., after the light pulse has been reflected by an object in the environment). The dToF depth camera may, based on the time of flight and the speed of light, calculate a distance between the dToF depth camera and the object in the environment.

An indirect Time-of-Flight (iToF) depth camera may measure a phase difference between an emitted light pulse and the light pulse as received by the iToF depth camera after the light pulse has been reflected by an object in the environment. The iToF depth camera may relate the phase difference to a time of flight of the light pulse between emission and reception, based on the speed of light and the frequency of the light pulse. The iToF depth camera may, based on the time of flight and the speed of light, calculate a distance between the iToF depth camera and the object in the environment.

A depth camera (e.g., either a dToF depth camera or an iToF depth camera) may emit one more light pulses into an environment and determine depth information relative to the environment. For example, the depth camera may emit one or more light pulses and receive and focus reflected light pulses onto an array of sensors. Using the array of sensors, the depth camera may determine depths for each of a number of points within a field of view of the depth camera. The number of depths may be a depth representation of the environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to prece de the detailed description presented below.

Systems and techniques are described for enhancing depth representations. According to at least one example, a method is provided for enhancing depth representations. The method includes: obtaining a depth representation of a scene, the depth representation comprising depth values based on a time of flight (ToF) signal; obtaining amplitude values corresponding to the depth values of the depth representation, wherein the amplitude values are based on the ToF signal; and smoothing the depth values based on the depth values and the amplitude values.

In another example, an apparatus for enhancing depth representations is provided that includes at least one memory and at least one processor (e.g., configured in circuitry) coupled to the at least one memory. The at least one processor configured to: obtain a depth representation of a scene, the depth representation comprising depth values based on a time of flight (ToF) signal; obtain amplitude values corresponding to the depth values of the depth representation, wherein the amplitude values are based on the ToF signal; and smooth the depth values based on the depth values and the amplitude values.

In another example, a non-transitory computer-readable medium is provided that has stored thereon instructions that, when executed by one or more processors, cause the one or more processors to: obtain a depth representation of a scene, the depth representation comprising depth values based on a time of flight (ToF) signal; obtain amplitude values corresponding to the depth values of the depth representation, wherein the amplitude values are based on the ToF signal; and smooth the depth values based on the depth values and the amplitude values.

In another example, an apparatus for enhancing depth representations is provided. The apparatus includes: means for obtaining a depth representation of a scene, the depth representation comprising depth values based on a time of flight (ToF) signal; means for obtaining amplitude values corresponding to the depth values of the depth representation, wherein the amplitude values are based on the ToF signal; and means for smoothing the depth values based on the depth values and the amplitude values.

According to another example, a method is provided for enhancing depth representations. The method includes: obtaining a depth representation of a scene, the depth representation comprising depth values based on a time of flight (ToF) signal; obtaining amplitude values corresponding to the depth values of the depth representation, wherein the amplitude values are based on the ToF signal; and determining a mask for the depth values based on the depth values and the amplitude values.

In another example, an apparatus for enhancing depth representations is provided that includes at least one memory and at least one processor (e.g., configured in circuitry) coupled to the at least one memory. The at least one processor configured to: obtain a depth representation of a scene, the depth representation comprising depth values based on a time of flight (ToF) signal; obtain amplitude values corresponding to the depth values of the depth representation, wherein the amplitude values are based on the ToF signal; and determine a mask for the depth values based on the depth values and the amplitude values.

In another example, a non-transitory computer-readable medium is provided that has stored thereon instructions that, when executed by one or more processors, cause the one or more processors to: obtain a depth representation of a scene, the depth representation comprising depth values based on a time of flight (ToF) signal; obtain amplitude values corresponding to the depth values of the depth representation, wherein the amplitude values are based on the ToF signal; and determine a mask for the depth values based on the depth values and the amplitude values.

In another example, an apparatus for enhancing depth representations is provided. The apparatus includes: means for obtaining a depth representation of a scene, the depth representation comprising depth values based on a time of flight (ToF) signal; means for obtaining amplitude values corresponding to the depth values of the depth representation, wherein the amplitude values are based on the ToF signal; and means for determining a mask for the depth values based on the depth values and the amplitude values.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example system including an enhancement engine that may enhance depth values based on amplitude values, according to various aspects of the present disclosure;

FIG. 2A is a diagram illustrating an example system for enhancing depth values, according to various aspects of the present disclosure;

FIG. 2B is a diagram illustrating a system for enhancing depth values, according to various aspects of the present disclosure;

FIG. 3 is a diagram illustrating an example system for enhancing depth values, according to various aspects of the present disclosure;

FIG. 4A is a diagram illustrating an example system for enhancing depth values, according to various aspects of the present disclosure;

FIG. 4B is a diagram illustrating an example system for enhancing depth values, according to various aspects of the present disclosure;

FIG. 5A is a diagram illustrating an example system for enhancing depth values, according to various aspects of the present disclosure;

FIG. 5B is a diagram illustrating an example system for enhancing depth values, according to various aspects of the present disclosure;

FIG. 6A is a diagram illustrating an example system for enhancing depth values based on amplitude values, according to various aspects of the present disclosure;

FIG. 6B is a diagram illustrating an example system for enhancing depth values based on amplitude values, according to various aspects of the present disclosure;

FIG. 7 is a flow diagram illustrating an example process for enhancing depth representations, in accordance with aspects of the present disclosure;

FIG. 8 is a flow diagram illustrating another example process for enhancing depth representations, in accordance with aspects of the present disclosure; and

FIG. 9 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As described above, direct Time-of-Flight (dToF) depth camera may determine a depth representation (e.g., depth values for a number of points in an environment) based on a timing of time-of-flight (ToF) signals. For example, the dToF depth camera may determine times of flight between when light pulses are emitted and when the reflected light pulses are received. The dToF depth camera may determine the depth values based on the time of flight and the speed of light. Similarly, an indirect Time-of-Flight (iToF) depth camera may determine a depth representation (e.g., depth values for a number of points in an environment) based on a timing of ToF signals. For example, the iToF depth camera may determine phase differences between emitted light pulses and the light pulses as reflected. The iToF depth camera may further determine times of flight of the pulses based on the phase differences. The iToF depth camera may determine the depth values based on the time of flight and the speed of light. Techniques are needed to enhance depth representations (e.g., depth values determined using dToF or iToF depth cameras).

Systems, apparatuses, methods (also referred to as processes), and computer-readable media (collectively referred to herein as “systems and techniques”) are described herein for enhancing depth representations based on amplitudes of time-of-flight signals. For example, the systems and techniques described herein may receive a depth representation determined based on timing of time-of-flight signals and enhance the depth representation based on amplitudes of the time-of-flight signals. The systems and techniques may be applied to dToF systems and techniques, to iToF systems and techniques, and/or other types of ToF systems and techniques. Accordingly, the term “time of flight” (ToF) used herein may refer to dToF systems and techniques, iToF systems and techniques, and/or to any other type of ToF systems and techniques.

The systems and techniques may obtain depth values based on a ToF signal and amplitude values based on the ToF signal. The amplitude values may correspond to the depth values. For example, a depth value may be based on the timing of a reflected light pulse and a corresponding amplitude value may be based on the amplitude of the reflected light pulse. In some aspects, the depth values may be arranged in a two-dimensional grid corresponding to points in the environment from which the light pulses were reflected (e.g., based on individual detectors or based on a scanning pattern). In such aspects, the depth values may be referred to as “depth pixels.” Each amplitude value may correspond to a depth value, in which case the amplitude values may also be arranged in a two-dimensional grid.

As a first example of enhancing depth values (e.g., of a depth representation), the systems and techniques may smooth the depth values based on amplitude values. For example, the systems and techniques may determine a noise threshold based on the depth values and the amplitude values. For instance, the systems and techniques may obtain a relationship between noise levels, depths, and amplitudes. In some examples, the systems and techniques may obtain a lookup table (LUT) that may receive a depth value and an amplitude value as inputs (or indices) and return a noise level. Each of the noise levels may be related to a representation or characteristic (e.g., a standard deviation) of noise for a window of depth values measured at a corresponding depth and at a corresponding amplitude. In some aspects, the noise levels may be used as noise thresholds. In some cases, one noise threshold may be determined for each depth value (e.g., based on the depth value and the corresponding amplitude value).

According to some aspects, the systems and techniques may adaptively filter each of the depth values based on the respective noise thresholds. For example, the systems and techniques may adaptively filter each of the depth values by identifying a respective window of depth values around the depth value (e.g., according to the two-dimensional grid). Because the window is defined around the depth value, the depth value may be referred to as a center depth value. The systems and techniques may generate an adaptive filter corresponding to each window. In generating the adaptive filter, the systems and techniques may filter out any of the depth values that are outside the noise threshold from the center depth value (e.g., by setting the weight of such depth values to zero in the adaptive filter). The filter may include weights for the remaining values (e.g., based on a distance in the two-dimensional grid from the center depth value). The systems and techniques may determine a weighted average for the window (by multiplying the depth values of the window by corresponding values of the filter) and store the weighted average as a smoothed depth value for the center depth value. The systems and techniques may adaptively filter each depth value of the depth representation to generate a smoothed depth representation. Smoothing depth values may enhance depth representations by causing flat surfaces to have uniform depths (e.g., removing noise in the depth values).

As a second example of enhancing depth values (e.g., of a depth representation), the systems and techniques may generate a depth mask for the depth values. The depth mask may be indicative of confidence values for the depth values. Other systems and techniques may rely on the confidence values to make determinations regarding how to use the depth values. For example, in some cases, the other systems and techniques may determine to not use depth values with confidence values below a confidence threshold. The systems and techniques may generate the depth mask based on the depth values and/or the amplitude values.

As a first example of generating a depth mask for the depth values, the systems and techniques may determine amplitude thresholds based on the depth values and determine the depth mask by comparing the amplitude values to the amplitude thresholds. For example, the systems and techniques may obtain a relationship between depths and amplitude thresholds. As an example, the systems and techniques may obtain a lookup table (LUT) that may receive a depth value as an input (or index) and return an amplitude threshold. Each of the amplitude thresholds may be related to an amplitude for a window of amplitude values measured at a corresponding depth. The depths and the corresponding amplitude thresholds may be stored in the LUT.

As described above, the systems and techniques may obtain depth values and corresponding amplitude values. The systems and techniques may determine an amplitude threshold for each of the depth values based on the relationship between depth values and amplitude thresholds. Each of the amplitude values may correspond to a depth value and may thus be related to an amplitude threshold. The systems and techniques may compare each amplitude value to a corresponding amplitude threshold. The systems and techniques May determine the depth mask based on which amplitude values exceed their corresponding amplitude threshold. For example, the amplitude values that are greater than or less than the amplitude threshold may be masked.

The depth mask may indicate depth values that should be used with low confidence. An amplitude that is outside the amplitude threshold may indicate that the corresponding depth value may be inaccurate and/or should be used with low confidence. Points in an environment that are distant from the ToF camera and/or points on objects with low reflectivity may reflect ToF signals at a low amplitude. Depth mask according to the first example may mask or identify such pixels.

As a second example of generating a depth mask for the depth values, the systems and techniques may locally amplify a contrast in amplitude values, then compare the contrast-amplified amplitude values with an amplitude threshold to determine the depth mask. For example, as described above, the systems and techniques may obtain depth values and corresponding amplitude values. The systems and techniques may locally amplify a contrast in the amplitude values. For example, the systems and techniques may determine windows of amplitude values and amplify contrast within the windows. For instance, the systems and techniques may, for a given window, determine an average amplitude value of the window and compare the average amplitude value to an amplitude value of a center amplitude value of the window. The systems and techniques may scale a difference between the center amplitude value and the average amplitude value of window. For example, the systems and techniques may multiply the difference by a factor. The systems and techniques may store the scaled difference as a new contrast-amplified amplitude value for the center amplitude value in a contrast-amplified amplitude representation. The systems and techniques may compare each of the contrast-amplified amplitude values to an amplitude threshold to determine the depth mask. In some cases, the amplitude threshold may be determined as described above with regard to the first example of generating a depth mask. Alternatively, the amplitude threshold may be determined in some other way.

Objects, such as reflective objects, close to a ToF camera may scatter reflections. The ToF camera may receive scattered reflections at depth sensors that do not correspond to the object from which the reflections were scattered. The ToF camera may determine that scattered reflections are depth values. Thus, close objects may result in inaccurate depth values around such objects. A depth mask according to the second example may mask or identify such pixels (e.g., by amplifying a contrast between such pixels and surrounding pixels such that the amplified pixels are not within the amplified threshold). For example, as scattering lights impact low-amplitude pixels, observed amplitude values for such pixels are higher than their real value, in which case it is difficult to identify them using an amplitude threshold (e.g., using the first example above of generating a depth mask for depth values). By amplifying contrast according to the second example, the low-amplitude pixels can be forced to be even lower values, in which case the amplitude threshold can be used to detect them.

As a third example of generating a depth mask for the depth values, the systems and techniques may generate a depth threshold based on depth values and based on amplitude values, and may then determine the mask based on the depth values and the depth threshold. For instance, the systems and techniques may obtain a relationship between depth thresholds, depths, and amplitudes. As an example, the systems and techniques may obtain a lookup table (LUT) that may receive a depth value and an amplitude value as inputs (or indices) and return a depth threshold. In some cases, each of the depth thresholds may be related to noise for a window of depth values measured at a corresponding depth and with a corresponding amplitude.

The systems and techniques may determine whether to mask the depth values based on the depth threshold. For example, the systems and techniques may identify a respective window of depth values around (e.g., according to the two-dimensional grid) each depth value. Because the window is defined around the depth value, the depth value may be referred to as a center depth value. The systems and techniques may determine whether to mask the center depth value based on the depth values of the window and the depth threshold. For example, the systems and techniques may determine how many depth values of the window of depth values are with the depth threshold. The systems and techniques may determine whether to mask the center depth value based on the number of depth values of the window that are within the depth threshold. For example, if more than half of the depth values of the window are within the depth threshold, the systems and techniques may determine to not mask the center depth value of the window. On the other hand, if fewer than half of the depth values of the window are within the threshold, the systems and techniques may determine to mask the center depth value.

Depth values derived from points at edges of objects may be complicated. For example, a detector of an array of detectors of a ToF camera may correspond to a point in the environment. For instance, ToF reflections from the point may be focused onto the detector of the array of detectors. Each detector of the array of detectors may correspond to a respective point in the environment. However, at edges of objects, there may be multiple reflections that are received by a single detector. For example, at the edge of an object, the object and a point behind the object may both reflect light to a single detector. The single detector may then calculate two different depth values based on the two different reflections. In some cases, a ToF camera may average between the two depth values to determine a final depth value. Such occurrences may be referred to in the art as “flying pixels.” Depth mask according to the third example may mask or identify such depth values (e.g., by identifying, or masking, depth values that are different from neighboring depth values, such as depth values within the same window). For example, a single detector may receive lights based on two different surface reflections, in which case the computed depth based on the received signals at single detector may contain large errors, which can appear as flying away from the real object surface (referred to as “flying pixels”). The depth mask technique according to the third example can be used to identify such flying pixels, such as by identifying an object depth boundary, which contains larger discontinuities. For instance, as described herein, the depth mask technique according to the third example can identify pixels with larger discontinuities in depth and can count the number of such pixels in a neighborhood or window.

Various aspects of the application will be described with respect to the figures below.

In the present disclosure, the terms “light,” “light pulse,” and like terms may refer to electromagnetic radiation of any frequency, whether in the spectrum of visible light or not. In the present disclosure, the terms “time-of-flight signal,” “ToF signal,” and like terms, may refer to a light pulses emitted and/or received by a ToF system (e.g., an emitter and a detector). References to the timing of a ToF signal may refer to a determined time of flight of a light pulse between when it is emitted and when the reflected pulse is received. Because such timing may be determined based on a phase difference, references to the timing of ToF signals may include measures of phase and/or phase differences. References to amplitudes of ToF signals may refer to a measured amplitude of a reflected light pulse. Further, because the amplitude of the reflected light pulse may be based, at least in part, on the amplitude of the emitted light pulse, references to amplitudes of ToF signals may be based on a difference between an amplitude of an emitted light pulse and an amplitude of the reflected light pulse. In the present disclosure, the term “object,” when referring to an environment, may include discrete objects, points on objects, and points in the environment including the ground and/or walls etc. In the present disclosure, the term “depth” may refer to a distance between a sensor (e.g., of an iToF depth camera) and an object.

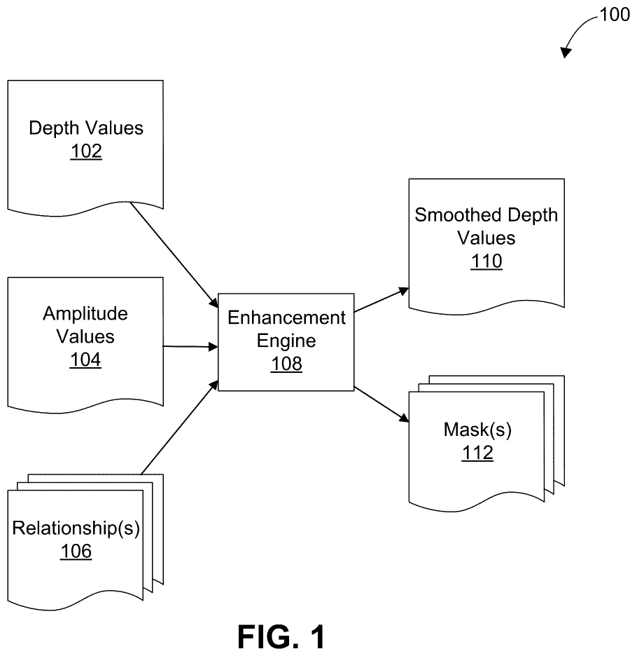

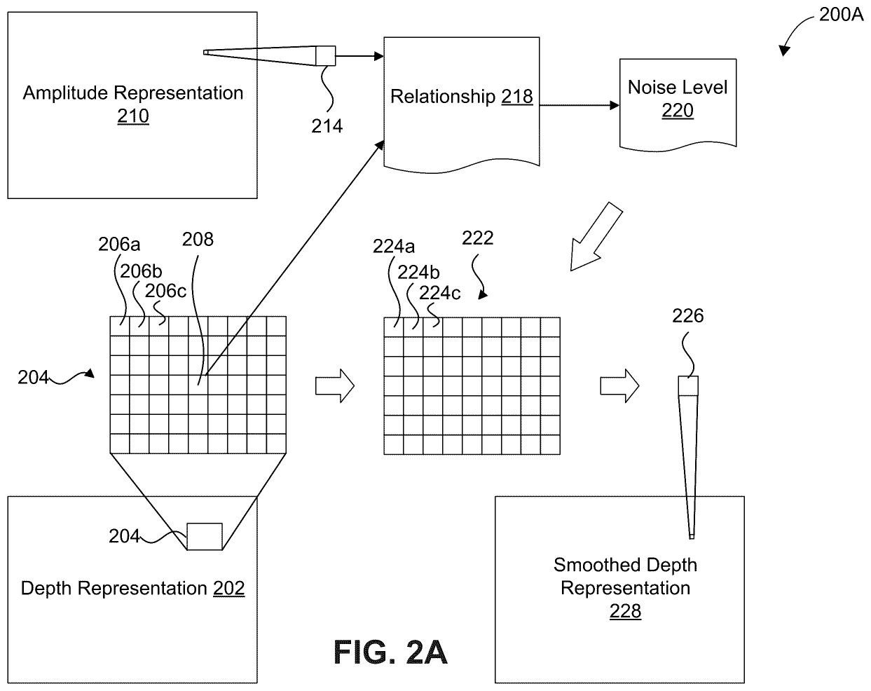

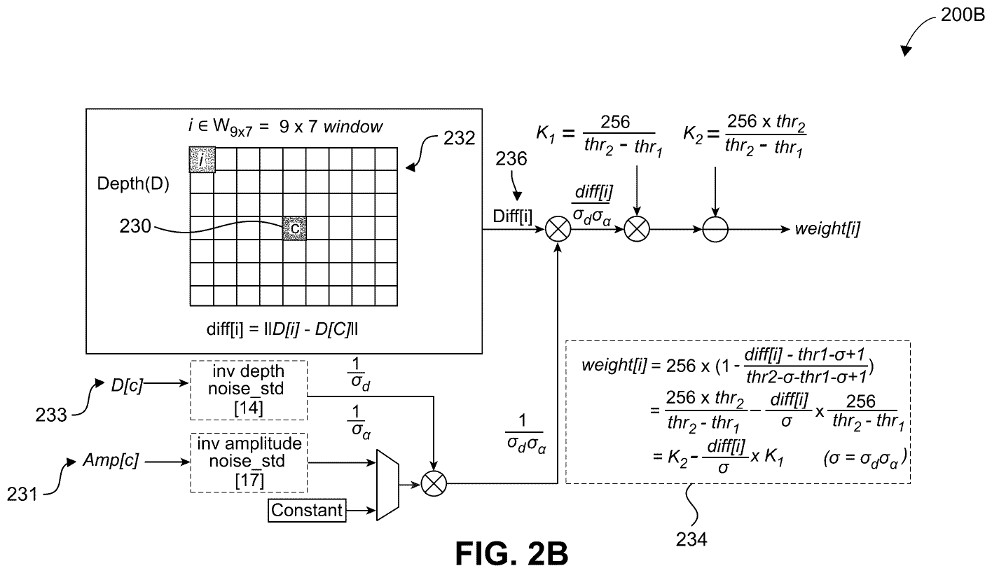

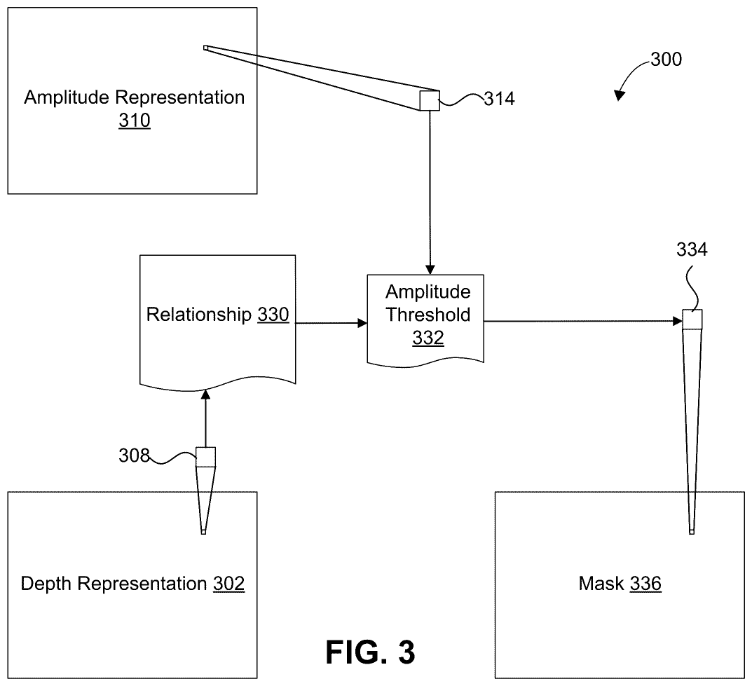

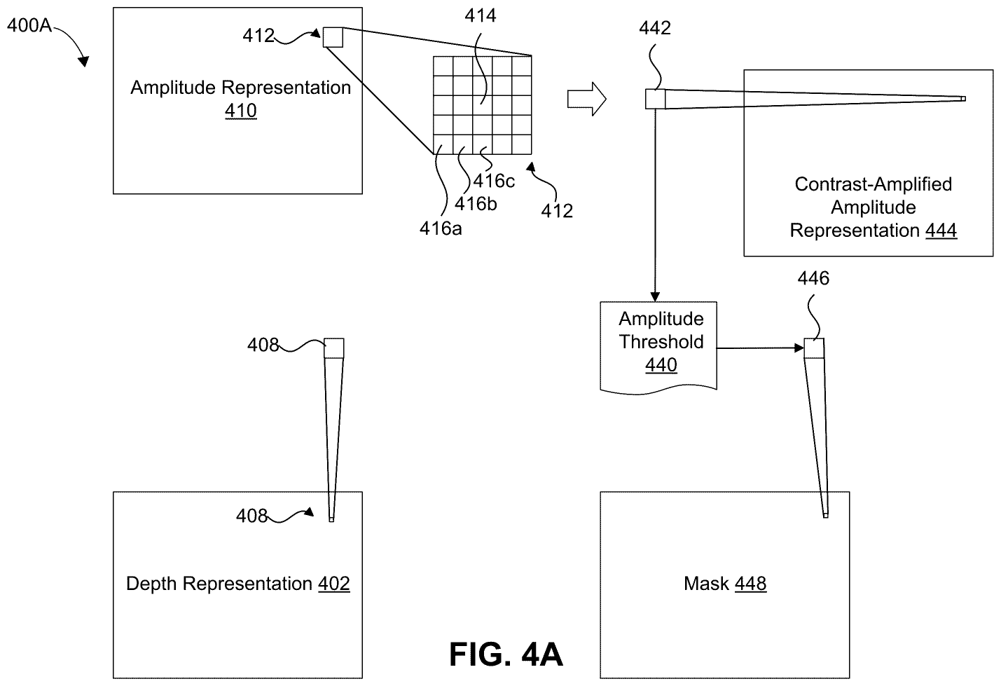

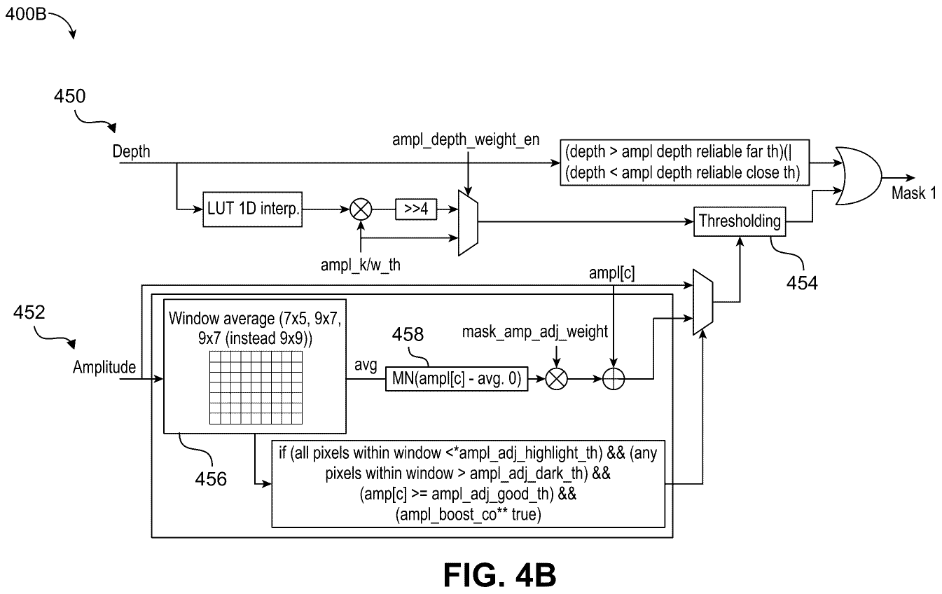

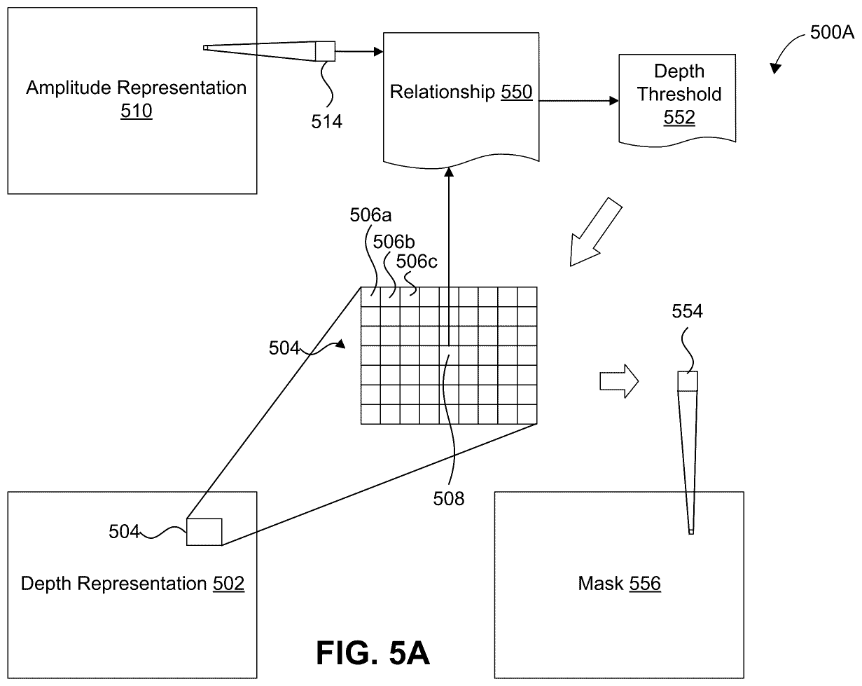

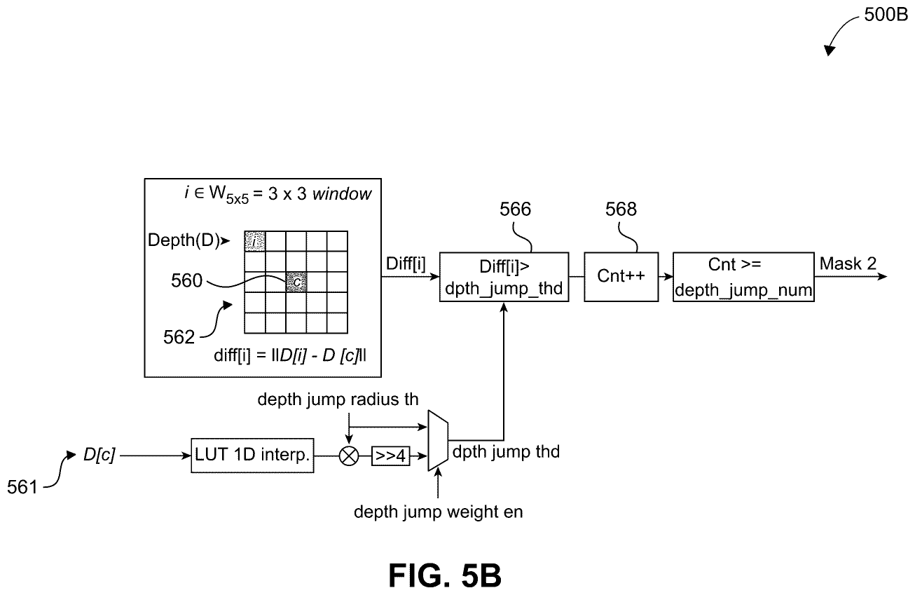

FIG. 1 is a diagram illustrating an example system 100 including an enhancement engine 108 that may enhance depth values 102 based on amplitude values 104, according to various aspects of the present disclosure. According to a first aspect, enhancement engine 108 may receive depth values 102, amplitude values 104, and/or one or more relationship(s) 106 and smooth depth values 102 (e.g., by adaptively filtering depth values 102) based on depth values 102, amplitude values 104, and relationship(s) 106 to generate smoothed depth values 110. Additional details regarding the first aspect are described with regard to FIG. 2A and FIG. 2B. According to a second aspect, enhancement engine 108 may receive depth values 102, amplitude values 104, and relationship(s) 106 and generate an amplitude threshold based on depth values 102, amplitude values 104, and relationship(s) 106. Enhancement engine 108 may generate a depth mask of mask(s) 112 by comparing amplitude values 104 to the amplitude threshold. Additional details regarding the first aspect are described with regard to FIG. 3. According to a third aspect, enhancement engine 108 may receive amplitude values 104 and amplify a contrast (e.g., within local windows) of amplitude values 104. Further enhancement engine 108 may generate a depth mask of mask(s) 112 by comparing the contrast-amplified amplitude values to an amplitude threshold. Additional details regarding the first aspect are described with regard to FIG. 4A and FIG. 4B. According to a fourth aspect, enhancement engine 108 may receive depth values 102, amplitude values 104, and relationship(s) 106 and generate a depth threshold based on depth values 102, amplitude values 104, and relationship(s) 106. Enhancement engine 108 may generate a depth mask of mask(s) 112 by comparing depth values 102 to the depth threshold. Additional details regarding the first aspect are described with regard to FIG. 5A and FIG. 5B.

Depth values 102 may be, or may include, depth values determined based on timings of ToF signals. For example, each of the depth values may be determined based on a timing of an emitted ToF signal (e.g., light pulse) and a reflected ToF signal (e.g., the light pulse as reflected). The depth values may be determined using a dToF depth-determination technique (e.g., a directly determined time of flight) or an iToF depth-determination technique (e.g., based on a phase difference). Depth values 102 may include discrete depth values. Depth values 102 collectively may be a depth representation (e.g., a depth representation of a scene captured by a ToF camera).

Amplitude values 104 may be, or may include, amplitude values based on the ToF signals. For example, amplitude values 104 may be, or may include, amplitude measurements of the reflected ToF signals used to determine depth values 102. Each of amplitude values 104 may correspond to one of depth values 102. For example, for each reflected ToF signal, the timing of the ToF signal may be used to determine a depth value of depth values 102 and the amplitude of the ToF signal may be stored as an amplitude value of amplitude values 104.

Relationship(s) 106 may include one or more relationships between amplitude values and/or depth values and noise levels, amplitude thresholds, and/or depth thresholds. According to the first aspect, relationship(s) 106 may include a relationship between depth values, amplitude values, and noise levels. For example, relationship(s) 106 may include a noise level for each combination of a respective depth and a respective amplitude. According to the second aspect, relationship(s) 106 may include a relationship between depth values and depth amplitude thresholds. For example, relationship(s) 106 may include an amplitude threshold for each depth value. According to the fourth aspect, relationship(s) 106 may include a relationship between depth values, amplitude values, and depth thresholds. For example, relationship(s) 106 may include a depth threshold for each combination of a respective depth and a respective amplitude.

Smoothed depth values 110 may be an enhanced version of depth values 102. For example, smoothed depth values 110 may include depth values similar to depth values 102. However, the depth values of smoothed depth values 110 may be smoothed. For example, similar depth values that are proximate to one another may be smoothed to have depths that are even more similar. Smoothing may give render flat surfaces with a more uniform depth in smoothed depth values 110 than in depth values 102.

Mask(s) 112 may be indicative of confidence values for depth values 102 (or smoothed depth values 110). For example, mask(s) 112 may indicate a confidence with which other systems and techniques may use depth values 102 (or smoothed depth values 110). Mask(s) 112 may include one or more individual masks which may be determined according to one or more aspects. For example, mask(s) 112 may include one mask determined according to the second aspect, another mask determined according to the third aspect, and yet another mask determined according to the fourth aspect. In some case, mask(s) 112 may include one mask determined according to multiple aspects. The information of the multiple masks may be combined in a number of ways. For example, a low confidence value according to any of the aspects may result in a low confidence value in the one mask. As another example, a low confidence value in a majority of masks will result in a low confidence value.

In some cases, mask(s) 112 may include one value for each of depth values 102. In other cases, mask(s) 112 may include one value corresponding to multiple (e.g., a group of) depth values 102. In some cases, mask(s) 112 may be binary (e.g., with a 0 indicating a high confidence value and a 1 indicating a low confidence value). In other cases, mask(s) 112 may include any value (e.g., represented by an eight-bit (or more) number). In some cases, mask(s) 112 may be implemented with bits of depth values 102 (or smoothed depth values 110). For example, a most-significant bit of a depth value of depth values 102 (or smoothed depth values 110) may be altered to reflect the confidence value of the depth value.

FIG. 2A is a diagram illustrating an example system 200A for enhancing depth values, according to various aspects of the present disclosure. In general, system 200A may adaptively filter depth representation 202 to generate smoothed depth representation 228. As part of the adaptive filtering, system 200A may apply a depth threshold to depth values of a window 204 or determine filter 222 based on the depth threshold.

Depth representation 202 may be, or may include, a number of depth values. Depth representation 202 may be an example of depth values 102 of FIG. 1. Depth representation 202 may be determined by a ToF camera and may be representative of a scene. Depth representation 202 may include a number of discrete depth values. The discrete depth values may be arranged in a two-dimensional grid (e.g., as depth pixels). Depth representation 202 may be divided into a number of windows. The windows may have any size. A window 204 is provided as an example. Window 204 includes depth values arranged in nine columns and seven rows. Window 204 includes depth value 206a, depth value 206b, depth value 206c, etc. (which may be collectively referred to as depth values 206). Window 204 includes depth values 206 that are around center depth value 208. Window 204 may be defined by center depth value 208 (e.g., window 204 may be defined as being centered on and including depth values around center depth value 208).

Amplitude representation 210 may be, or may include, a number of amplitude values. Amplitude representation 210 may be an example of amplitude values 104 of FIG. 1. Amplitude representation 210 may be captured by a the ToF camera which determined depth representation 202. Each amplitude value of amplitude representation 210 may correspond to a depth value of depth representation 202. For example, each amplitude value of amplitude representation 210 may be representative of an amplitude of a reflected signal used to determine a depth value of depth representation 202. As an example, amplitude value 214 may correspond to center depth value 208. Specifically, amplitude value 214 may represent the amplitude of the reflected signal that was used to determine center depth value 208.

System 200A may receive depth representation 202 and amplitude representation 210. System 200A may smooth each depth value of depth representation 202. As an example, the process of smoothing is described with regard to center depth value 208. For example, window 204 may be identified based on center depth value 208 and amplitude value 214 may be identified based on center depth value 208.

System 200A may determine noise level 220 based on amplitude value 214 and center depth value 208. For example, system 200A may obtain relationship 218. Relationship 218 may define a noise level for each combination of a respective depth and a respective amplitude. Relationship 218 may be implemented as a lookup table (LUT). In such cases, center depth value 208 and amplitude value 214 may be used as indices into the LUT and noise level 220 may be the output. Alternatively, in some cases, relationship 218 may be defined by one or more equations. In such cases, center depth value 208 and amplitude value 214 may be input into the equation and noise level 220 may be output.

System 200A may be provided with relationship 218. Relationship 218 may be an example of one of relationship(s) 106 of FIG. 1. Relationship 218 may be determined through a calibration process. For instance, a ToF camera may determine depth measurements and amplitude measurements by measuring depth values between the ToF depth camera and a surface that is a predetermined distance from the ToF camera. The depth measurements and amplitude measurements may be repeated at a number of predetermined distances. In the calibration process, a standard deviation of noise (e.g., noise in the depth measurements of a window) may be determined for a number of depths and for a number of amplitudes. The standard deviations of the noise, the corresponding depths, and the corresponding amplitudes may be stored as the relationship. In some aspects, the standard deviations of noise may be the noise levels 220. For example, amplitude is a signal magnitude, and can be computed based on the I and Q signals. Even for the same depth position, objects with lower amplitude are noisier than objects with high amplitude. The amplitude of the object can thus be used as a guidance to adjust (e.g., increase) the depth domain denoise strength (e.g., by adjusting the depth noise standard deviation value to be higher.

System 200A may generate a filter 222 for center depth value 208. Because system 200A may generate a filter for each depth value of depth representation 202, filter 222 may be referred to as an adaptive filter. By generating a filter for each depth value of depth representation 202, system 200A may adaptively filter depth representation 202.

Filter 222 may include weight 224a, weight 224b, weight 224c, etc. (which may be collectively referred to as weights 224). Each of weights 224 may correspond to one of depth values 206 (including center depth value 208). For example, weight 224a may correspond to depth value 206a. System 200A may multiply each of depth values 206 (and center depth value 208) by respective weights 224 of filter 222 and sum the result to determine smoothed center depth value 226. Smoothed center depth value 226 may be a new value for center depth value 208. System 200A may store smoothed center depth value 226 in smoothed depth representation 228. Smoothed depth representation 228 may be depth representation 202 smoothed. Smoothed depth representation 228 may be an example of smoothed depth values 110 of FIG. 1. Weights 224 of filter 222 may sum to 1 such that filter 222 may not scale depth values. In some cases, weights 224 of filter 222 may be set based on a distance between the weight (in the two-dimensional grid of filter 222) and the center of filter 222. For example, weights 224 of filter 222 may have a gaussian distribution. As an example, weight 224c may be greater than weight 224b based on weight 224c being closer to a center of filter 222 than weight 224b is to the center of filter 222.

Additionally, the depth values of window 204 that are averaged to generate smoothed center depth value 226 may be based on noise level 220. For example, depth values 206 that are greater than noise level 220 from center depth value 208 may be excluded from the averaging used to generate smoothed center depth value 226. For example, each of depth values 206 may be compared to center depth value 208. Each of depth values 206 that are greater than noise level 220 away from center depth value 208 may be excluded from inclusion when averaging the depth values 206 to generate smoothed center depth value 226. As an example, if depth value 206a is greater than noise level 220 away from center depth value 208 (in depth), weight 224a may be set to zero.

By smoothing depth representation 202 to generate smoothed depth representation 228, system 200A may enhance depth representation 202. For example, by smoothing each depth value of depth representation 202, based on a respective window, system 200A may cause depth values that are very different from their neighboring depth values to be more similar to their neighboring depth values. Further, by smoothing based on noise level 220, system 200A may retain sharp edges in smoothed depth representation 228. For example, by smoothing based on noise level 220, system 200A may ensure that, within a window, depth values that are very different from their neighbors, beyond the effects of noise, do not affect the smoothing. Further, by using amplitude representation 210 and depth representation 202 to determine noise level 220 (based on relationship 218), system 200A may cause the thresholding (based on noise level 220) to be more accurate. For example, relationship 218 may provide additional detail and/or accuracy when determining noise level 220 than other techniques may have when determining other thresholds.

FIG. 2B is a diagram of an example system 200B for enhancing depth values via depth smoothing, according to various aspects of the present disclosure. For example, the system 200B can be implemented by a depth smoothing filter in some aspects. System 200B may be an example of system 200A of FIG. 2A. For example, system 200B may determine weights (e.g., shown as weight[i] 234 in FIG. 2B) for an adaptive filter that may be used to filter depth representations D to generate smoothed depth representation. As part of determining the adaptive filter, system 200B may use a depth-noise standard deviation (also denoted as inv_noise_std),

$$\frac{1}{{σ}_{d} {σ}_{α}} ,$$

in relation to depth values Depth (D) of a window 232.

A depth smoothing filter may be similar to a joint bilateral filter in an image quality (IQ) signal-to-noise ratio (SNR). For instance, for filtering, a joint bilateral filter in an IQ SNR may use a window of a particular size (e.g., a 9×7 window) and a single depth input. In contrast, depth smoothing as described herein may use two inputs, depth and amplitude, to calculate thresholds for weights. Using both amplitude information 231 (shown as Amp[c]) and depth information 233 (where Amp[c] and D[c] indicates a current amplitude input and a current depth input, respectively) to adaptively filter depth representations, as described herein, provides various advantages. Depth denoise strength may be based on depth noise information and amplitude information.

As shown in FIG. 2B, a window 232 may be selected (e.g. the 9×7 window) around a center pixel 230. Smoothing generally may include using values within the window to smooth a center value (e.g., a value of center pixel 230). Smoothing a center pixel based on a window may be advantageous (e.g., to remove noise) when the window represents a flat surface having a relatively uniform depth. If there are different depth surfaces within the window, it may be advantageous to remove the separate depth surfaces before smoothing a center pixel based on the values of the window.

To determine whether depth values of the window are different from the depth values of the center value based on noise or based on the depth values coming from different depth surfaces, the system 200B may compare the depth values to the center depth value to generate difference values 236 (shown in FIG. 2B as diff[i]). The difference values 236 (diff[i]) may be compared with noise values to determine whether the depth values are noise (e.g., within a noise threshold) or based on different depths (e.g., outside the noise threshold).

The system 200B may use depth information 233 (e.g., current depth value D[c]) and amplitude information 231 (e.g., current amplitude value Amp[c]) to determine the depth-noise standard deviation

$$\frac{1}{{σ}_{d} {σ}_{α}} .$$

The depth-noise standard deviation may be based on standard deviations of depth values at the depth and/or amplitude. For instance, there may be a linear (or substantially linear) relationship between depth values D[c] and noise. In one illustrative example, at 1 meter distance, there may be 1% noise. In another illustrative example, at 3 meters distance, there may be 1-2% noise. Additionally, there may be a relationship between amplitude and noise.

Noise information is inherent to a ToF sensor. In calibration, a depth of a flat field may be captured. Because of the flat field, there may be substantially no change in depth in the depth representation. However, the depth representation may include variations in depth measurements due to noise. The noise may be recorded for various depths and/or amplitudes. The recorded noises for depths and/or amplitudes may be used as a LUT to determine a noise for a particular depth. For instance, for a depth value of the center pixel 230 that is currently being analyzed from a sensor (e.g., an iToF depth camera or sensor), a LUT can specify a particular noise value that calibration of the sensor indicated is associated with the particular depth value of the center pixel 230. System 200B can then adjust the noise level based on the amplitude of the brightness for the center pixel 230. For example, the noise may be increased if the amplitude is low, and the noise may be decreased if the amplitude is high. The adjustment of the noise affects whether depth values are determined to be noise, based on the comparison of the difference values 236 (diff[i]) with the noise values described previously.

As shown in FIG. 2B, system 200B can output a weight (denoted as weight[i]) that is then used by the depth smoothing filter. As in IQ SNR joint bilateral filtering, the weight calculation can be simplified with precalculated parameters, such as using the following formulation:

$$weight [ i ] = {K}_{2} - {K}_{1} \times \frac{diff [ i ]}{{σ}_{d} {σ}_{a}} ,$$

$$where$$

$${K}_{1} = \frac{256}{thr 2 - thr 1}$$

$$and$$

$${K}_{2} = \frac{256 \times thr 2}{thr 2 - thr 1} .$$

To obtain the depth-noise standard deviation

$$\frac{1}{{σ}_{d} {σ}_{α}} ,$$

system 200B can use a center pixel 230 of the depth (D) and amplitude as indices to one or more LUTs, as described above. Using a center pixel of depth and amplitude each for indexing into a LUT, system 200B can read inv_depth_noise_std and inv_amplitude_noise_std values from the LUT.

With calculated weights, system 200B applies filtering, such as using the below equation:

$$sum\_D = {\sum }_{i ∈ {W}_{9 \times 7}} ( D [ i ] - D [ C ] ) \times weight [ i ]$$

$$sum\_weight = {\sum }_{i ∈ {W}_{9 \times 7}} weight [ i ]$$

$$LP\_value = \frac{sum\_D}{sum\_weight}$$

$${D}_{NR} = D [ C ] + {w}_{1} \times LP\_value \_soft$$

The system 200B can add one soft thresholding on an LP_value1 as below:

```
if (abs(LP_value1) < depth_soft_thd) {
    LP_value1_soft = 0;
  }
else {
    LP_value1_soft = sign(LP_value1) * ( abs(LP_value1) −
    depth_soft_thd) ;
  }
```

FIG. 3 is a diagram illustrating an example system 300 for enhancing depth values, according to various aspects of the present disclosure. In general, system 300 may generate a mask 336 based on depth representation 302, amplitude representation 310, and relationship 330. Mask 336 may include confidence values indicative of respective levels of confidence with which other systems and techniques may use respective depth values of depth representation 302. System 300 may thus enhance depth representation 302 by indicating how confident other systems and techniques may be in using the depth values of depth representation 302.

Depth representation 302 may be, or may include, a number of discrete depth values (of which depth value 308 is an example). The discrete depth values may be arranged in a two-dimensional grid (e.g., as depth pixels). Depth representation 302 may be determined by a ToF camera and may be representative of a scene. Depth representation 302 may be an example of depth values 102 of FIG. 1. Depth representation 302 may the same as, or may be substantially similar to, depth representation 202 of FIG. 2A. Alternatively, depth representation 302 may be the same as, or may be substantially similar to, smoothed depth representation 228 of FIG. 2A. For example, system 300 may obtain smoothed depth values and generate mask 336 based on smoothed depth values.

Amplitude representation 310 may be, or may include a number of amplitude values, each of which may correspond to a respective one of depth representation 302. Amplitude representation 310 may be an example of amplitude values 104 of FIG. 1. Amplitude representation 310 may be the same as, or may be substantially similar to, amplitude representation 210 of FIG. 2A. Amplitude representation 310 may be captured by a the ToF camera which determined depth representation 302. Each amplitude value of amplitude representation 310 may correspond to a respective depth value of depth representation 302. For example, each amplitude value of amplitude representation 310 may be representative of an amplitude of a reflected signal used to determine a depth value of depth representation 302. As an example, amplitude value 314 may correspond to depth value 308. Specifically, amplitude value 314 may represent the amplitude of the reflected ToF signal that was used to determine depth value 308.

System 300 may receive depth representation 302 and amplitude representation 310. System 300 may generate mask 336 based on each amplitude value of amplitude representation 310 and based on each corresponding depth value of depth representation 302. As an example, the process generating mask value 334 of mask 336 based on amplitude value 314 and depth value 308 is described. Mask 336 may be an example of one of mask(s) 112 of FIG. 1.

System 300 may determine amplitude threshold 332 based on depth value 308. Amplitude threshold 332 may be a threshold for determining mask value 334 based on amplitude value 314. For example, system 300 may determine mask value 334 by comparing amplitude value 314 to amplitude threshold 332. For instance, if amplitude value 314 is within amplitude threshold 332, system 300 may generate mask value 334 to indicate a high confidence and if amplitude value 314 is outside amplitude threshold 332, system 300 may generate mask value 334 to indicate a low confidence. Mask value 334 may be a value of mask 336. Mask value 334 may correspond to depth value 308. For example, mask value 334 may be indicative of a confidence value for depth value 308.

System 300 may obtain relationship 330. Relationship 330 may define an amplitude threshold for a number of respective depth values. Relationship 330 may be implemented as a lookup table (LUT). In such cases, depth value 308 may be used as an index into the LUT and amplitude threshold 332 may be the output. Alternatively, in some cases, relationship 330 may be defined by one or more equations. In such cases, depth value 308 may be input into the equation and amplitude threshold 332 may be output.

For instance, the strength of reflected IR light (the amplitude) will fall inversely to the depths. In one illustrative example, the farther away an object is (in the depth domain, such as relative to the IR sensor) the weaker the reflection (amplitude) from the object is. In another example, the closer the object is (in the depth domain), the stronger the reflection (amplitude) from the object is. In this way, instead of setting a constant amplitude threshold, the systems and techniques can take advantage of the relationship between depth and amplitude. Accordingly, the systems and techniques adjust the threshold to be lower when the depths value is high. On the other hand, when a depths value is lower (e.g., the object is close to the IR sensor), the amplitude is adjusted to be higher. The systems and techniques can thus filter out depth pixels, which can preserve good pixels, even though those pixels may be farther away from the sensor and may have a weak signal (e.g., amplitude).

System 300 may be provided with relationship 330. Relationship 330 may be an example of one of relationship(s) 106 of FIG. 1. Relationship 330 may be determined through a calibration process. For instance, a ToF camera may determine depth measurements and amplitude measurements by measuring depth between the ToF depth camera and a surface that is a predetermined distance from the ToF camera. The depth measurements and amplitude measurements may be repeated at a number of distances. In the calibration process, a standard deviation of amplitude measurements (e.g., noise in the amplitude measurements of a window) may be determined for a number of depths. In some cases, the standard deviation of amplitude may be used as the amplitude threshold. The depths and the corresponding amplitude thresholds may be stored as relationship 330.

By masking depth representation 302 based on amplitude thresholds 332, system 300 may identify inaccurate depth values of depth representation 302. For example, system 300 may identify depth values of depth representation 302 that correspond to amplitude values that are inaccurate. For example, system 300 may identify depth values that correspond to amplitude values that are too intense or too dim for the distance from which the ToF signals were reflected.

FIG. 4A is a diagram illustrating an example system 400A for enhancing depth values, according to various aspects of the present disclosure. In general, system 400A may amplify a contrast between amplitude values of a window of amplitude representation 410. System 400A can generate a mask 448 based on the contrast-amplified amplitude values. Mask 448 may include confidence values indicative of respective levels of confidence with which other systems and techniques may use respective depth values of depth representation 402. Thus system 400A may enhance depth representation 402 by indicating how confident other systems and techniques may be in using the depth values of depth representation 402.

Depth representation 402 may include a number of discrete depth values (e.g., depth value 408). The discrete depth values may be arranged in a two-dimensional grid (e.g., as depth pixels). Depth representation 402 may be determined by a ToF camera and may be representative of a scene. Depth representation 402 may be an example of depth values 102 of FIG. 1. Depth representation 402 may the same as, or may be substantially similar to, depth representation 202 of FIG. 2A. Alternatively, depth representation 402 may be the same as, or may be substantially similar to, smoothed depth representation 228 of FIG. 2A. For example, system 400A may obtain smoothed depth values and generate mask 448 based on smoothed depth values. Additionally, or alternatively, depth representation 402 may be the same as, or may be substantially similar to, depth representation 302 of FIG. 3.

Amplitude representation 410 may be, or may include, a number of amplitude values (including, as an example, amplitude value 414). Amplitude representation 410 may be an example of amplitude values 104 of FIG. 1. Amplitude representation 410 may be the same as, or may be substantially similar to, amplitude representation 210 of FIG. 2A and/or amplitude representation 310 of FIG. 3. Amplitude representation 410 may be captured by a the ToF camera which determined depth representation 402. Each amplitude value of amplitude representation 410 may correspond to a depth value of depth representation 402. For example, each amplitude value of amplitude representation 410 may be representative of an amplitude of a reflected ToF signal used to determine a depth value of depth representation 402. As an example, amplitude value 414 may correspond to depth value 408. Specifically, amplitude value 414 may represent the amplitude of the reflected signal that was used to determine depth value 408.

System 400A may receive amplitude representation 410 and generate mask 448 based on each amplitude value of amplitude representation 410. As an example, the process generating mask value 446 of mask 448 based on amplitude value 414 is described. Mask 448 may be an example of one of mask(s) 112 of FIG. 1.

Amplitude representation 410 may be divided into a number of windows. The windows may have any size. A window 412 is provided as an example. Window 412 includes amplitude values arranged in five columns and five rows. Window 412 includes amplitude value 416a, amplitude value 416b, amplitude value 416c, etc. (which may be collectively referred to as amplitude values 416). Window 412 includes amplitude values 416 that are around amplitude value 414. Window 412 may be defined by amplitude value 414 (e.g., window 412 may be defined as being centered on and including amplitude values 416 around amplitude value 414).

System 400A may amplify a contrast of each amplitude value of amplitude representation 410 relative to its respective neighbors. For example, system 400A may amplify a contrast of amplitude value 414 relative to window 412. As an example, system 400A may determine an average of amplitude value 414. System 400A may compare amplitude value 414 to the average and determine a difference between amplitude value 414 and the average of window 412. System 400A may amplify the difference by multiplying the difference by a scaler. System 400A may store the scaled difference as contrast-amplified amplitude value 442 (e.g., a value to replace amplitude value 414 in contrast-amplified amplitude representation 444). Alternatively, system 400A may amplify the contrast by applying an unsharp mask (not illustrated in FIG. 4A) to amplitude value 414 to generate contrast-amplified amplitude value 442.

System 400A may compare contrast-amplified amplitude value 442 to an amplitude threshold 440 to determine mask value 446. For example, system 400A may determine mask value 446 by comparing contrast-amplified amplitude value 442 to amplitude threshold 440. For instance, if contrast-amplified amplitude value 442 is within amplitude threshold 440, system 400A may generate mask value 446 to indicate a high confidence and if contrast-amplified amplitude value 442 is outside amplitude threshold 440, system 400A may generate mask value 446 to indicate a low confidence. Mask value 446 may be a value of mask 448. Mask value 446 may correspond to depth value 408. For example, mask value 446 may be indicative of a confidence value for depth value 408.

In some cases, system 400A may be provided with amplitude threshold 440. For example, amplitude threshold 440 may be generated according to another aspect or by another system or technique. As an example, amplitude threshold 440 may be the same as, or may be substantially similar to, amplitude threshold 332 of FIG. 3 and may be generated according to a similar process. Alternatively, amplitude threshold 440 may be generated by some other process.

By masking depth representation 402 based on amplitude values, system 400A may identify inaccurate depth values of depth representation 402. For example, system 400a may identify depth values of depth representation 402 that are inaccurate. For example, system 400A may identify depth values that correspond to amplitude values that are too intense for the distance from which the ToF signals were reflected based on the amplitudes of neighboring amplitude values. For example, by amplifying the contrast between amplitude values, system 400A may cause bad amplitude values to stand out and be thresholded by amplitude threshold 440. System 400A may be useful to identify depth values that are the result of scattered energy. For example, an object close to a ToF camera may scatter ToF signals. The scattered ToF signals may be determined to be depth values. System 400A may amplify the difference between the amplitude values and neighboring amplitude values which may cause amplitudes resulting from scattered energy to stand out and thus be more accurately identified by amplitude threshold 440.

FIG. 4B is a diagram illustrating an example system 400B for enhancing depth values using amplitude-based masking, according to various aspects of the present disclosure. As shown, system 400B may accept two inputs, including depth 450 and amplitude 452. If amplitude 452 is out of range, the amplitude 452 can be masked. System 400B may detect invalid pixels impacted by scattering bright pixels, such as by adaptively boosting local contrast (e.g., dark pixels-distant pixels), so that the amplitude of the pixels would fall below a threshold to be identified as invalid. System 400B may detect flying pixels by adaptively adjust a depth discontinuity threshold based on amplitude information.

Scattering may refer to a close object that reflects emitted light pulses from the ToF system. The reflected light impacts surrounding pixel. Absent the scattering, the surrounding pixel maybe very easy to distinguish because the surrounding pixels may be different from the close object. But because of a scattering, the surrounding pixels may have closer values than they would otherwise. Thresholding by itself may not remove the depth values affected by scattering.

System 400B may amplify the contrast between pixels. In some cases, system 400B may cause the closer pixels to be closer (in the depth domain) and the distant pixels to be more distant (in the depth domain). In some cases, system 400B may perform a local contrast adjustment. One example of performing a local contrast adjustment is using an unsharpen mask to make the local contrast higher. A local contrast adjustment may cause the distant values to fall below the amplitude thresholds so the distant pixels can be identified.

Some sensors may have their own unique limitations. For example, a sensor may not be able to resolve distances that are too close or may not be able to accurately record distances that are too distant. The limitations may be used to filter out pixels. Such filtration may be based on depths.

Additionally, system 400B may detect invalid pixel based on amplitude values. For example, system 400B may threshold depth values based on corresponding amplitude values (shown as thresholding 454). System 400B may include a local-contrast-amplifying block. System 400B may take an average of a window (e.g., the window average 456) and may compare the value of each pixel with the average (e.g., using operation 458) to determine a difference. Some pixels will have a positive difference and others will have a negative difference. System 400B may amplify this difference, such as using a mask amplitude adjustment weight (shown in FIG. 4B as mask_amp_adj_weight). For example, a pixel may have a difference of −1 before the amplification and −5 after the amplification. Another pixel may have a difference of 2 before the amplification and 10 after the amplification. The amplified difference values may be compared to a threshold to determine the validity of pixels.

FIG. 5A is a diagram illustrating an example system 500A for enhancing depth values, according to various aspects of the present disclosure. In general, system 500A may determine one or more depth thresholds (e.g., depth threshold 552) based on amplitude values and depth values. System 500A can then generate a mask 556 based on the depth values and the one or more depth thresholds (e.g., depth threshold 552). Mask 556 may include confidence values indicative of respective levels of confidence with which other systems and techniques may use respective depth values of depth representation 502. System 500A may thus enhance depth representation 502 by indicating how confident other systems and techniques may be in using the depth values of depth representation 502.

Depth representation 502 may be, or may include, a number of discrete depth values which may be arranged in a two-dimensional grid (e.g., as depth pixels). Depth representation 502 may be determined by a ToF camera and may be representative of a scene. Depth representation 502 may be an example of depth values 102 of FIG. 1. Depth representation 502 may the same as, or may be substantially similar to, depth representation 202 of FIG. 2A. Alternatively, depth representation 502 may be the same as, or may be substantially similar to, smoothed depth representation 228 of FIG. 2A For example, system 500A may obtain smoothed depth values and generate mask 556 based on smoothed depth values. Additionally, or alternatively, depth representation 502 may be the same as, or may be substantially similar to, depth representation 302 of FIG. 3 and/or of depth representation 402 of FIG. 4A.

Depth representation 502 may be divided into a number of windows. The windows may have any size. A window 504 is provided as an example. Window 504 includes depth values arranged in nine columns and seven rows. Window 504 includes depth value 506a, depth value 506b, depth value 506c, etc. (which may be collectively referred to as depth values 506). Window 504 includes depth values 506 that are around center depth value 508. Window 504 may be defined by center depth value 508 (e.g., window 504 may be defined as being centered on and including depth values around center depth value 508).

Amplitude representation 510 may be, or may include, a number of amplitude values. Amplitude representation 510 may be an example of amplitude values 104 of FIG. 1. Amplitude representation 510 may be the same as, or may be substantially similar to, amplitude representation 210 of FIG. 2A, amplitude representation 310 of FIG. 3, and/or amplitude representation 410 of FIG. 4A. Amplitude representation 510 may be captured by the ToF camera which determined depth representation 502. Each amplitude value of amplitude representation 510 may correspond to a depth value of depth representation 502. For example, each amplitude value of amplitude representation 510 may be representative of an amplitude of a reflected signal used to determine a depth value of depth representation 502. As an example, amplitude value 514 may correspond to center depth value 508. Specifically, amplitude value 514 may represent the amplitude of the reflected signal that was used to determine center depth value 508.

System 500A may receive amplitude representation 510 and depth representation 502 and generate the depth threshold 552 based on each amplitude value of amplitude representation 410 and a corresponding depth value of depth representation 502. Further, system 500 A may determine mask values of mask 556 based on the depth values of depth representation 502 and the depth thresholds 552. As an example, the process generating mask value 554 of mask 556 based on amplitude value 514 and center depth value 508 is described. Mask 556 may be an example of one of mask(s) 112 of FIG. 1.

System 500a may determine depth threshold 552 based on amplitude value 514 and center depth value 508. For example, system 500A may obtain relationship 550. Relationship 550 may define a depth threshold for each combination of a respective depth and a respective amplitude. Relationship 550 may be implemented as a lookup table (LUT). In such cases, center depth value 508 and amplitude value 514 may be used as indices into the LUT and depth threshold 552 may be the output. Alternatively, in some cases, relationship 550 may be defined by one or more equations. In such cases, center depth value 508 and amplitude value 514 may be input into the equation and depth threshold 552 may be output.

System 500A may be provided with relationship 550. Relationship 550 may be an example of one of relationship(s) 106 of FIG. 1. Relationship 550 may be determined through a calibration process. For example, a ToF camera may determine depth measurements and amplitude measurements by measuring depth between the ToF depth camera and a surface that is a predetermined distance from the ToF camera. The depth measurements and amplitude measurements may be repeated at a number of predetermined distances. In the calibration process, a standard deviation of noise (e.g., noise in the depth measurements of a window) may be determined for a number of depths and for a number of amplitudes. The standard deviations of the noise, the corresponding depths, and the corresponding amplitudes may be stored as relationship 550. The standard deviations of noise may be the depth thresholds of relationship 550.

Having obtained depth threshold 552 (based on amplitude value 514 and center depth value 508), system 500A may use depth threshold 552 and depth values of window 504 to determine mask value 554. For example, system 500A may determine a number of depth values 506 of window 504 are within depth threshold 552 from center depth value 508. System 500A may determine mask value 554 based on the number of depth values 506 that are within depth threshold 552 of center depth value 508. For example, mask value 554 may be based on a percentage of depth values 506 that are within depth threshold 552 of center depth value 508. For example, mask value 554 may be represented by two bits and if 75% or more of depth values 506 are within depth threshold 552 of center depth value 508, then mask value 554 may be 11, if between 50% and 75% of depth values 506 are within depth threshold 552 of center depth value 508, mask value 554 may be 10, if between 25% and 50% of depth values 506 are within depth threshold 552 of center depth value 508, mask value 554 may be 01, and if less than 25% of depth values 506 are within depth threshold 552 of center depth value 508, mask value 554 may be 00.

By masking depth representation 502 based on amplitude values, system 500A may identify inaccurate depth values of depth representation 502. For example, system 500A may identify depth values of depth representation 502 are inaccurate. For example, system 500 A may identify depth values are too distant or close based on the amplitude values corresponding to such depth values. For example, by generating depth threshold 552 based on amplitude representation 510 and depth representation 502, system 500A may determine a threshold that reflects the relationship between the amplitude and the timing of ToF signals. Using depth thresholds 552, system 500A may identify flying pixels. Flying pixels may have depth values that are not related to their corresponding amplitude values by relationship 550.

FIG. 5B is a diagram illustrating an example system 500B for enhancing depth values using depth-based masking, according to various aspects of the present disclosure. System 500B may compile discontinuities in a small neighborhood around a current depth pixel 560 and adaptively adjust the thresholding to make the discontinuity evaluation more accurate. The system 500B can perform the depth-based masking by masking pixels with values that change too often compared to neighbor pixels.

As shown in FIG. 5B, system 500B can calculate differences between a current depth pixel 561 (shown as D[c]) and its neighbor depth pixels within a window 562 (e.g., a 3×3 window, as shown in FIG. 5B for illustrative purposes). The neighbor depth pixels are shown as D[i] in FIG. 5B, where i corresponds to each depth pixel in the window neighboring the current depth pixel 560. At operation 566, system 500B can determine whether each neighboring depth pixel i is farther (in depth) than a depth jump threshold (shown in FIG. 5B as dpth_jump_thd) from the current depth pixel 560. At operation 568, system 500B can count the number of neighboring depth pixels that are farther (in depth) than the depth jump threshold from the current depth pixel 560. If the count of the number of neighboring pixels that are farther than the threshold from the current depth pixel 560 is greater than a certain number (denoted as depth_jump_num in FIG. 5B), the current pixel will be masked. For example, if a value of the current depth pixel jumps by a certain amount as compared to values of neighboring depth pixel, the current depth pixel 560 will be masked.

Pixels representative of a single surface may have substantially the same depth, despite noise. However, at some boundaries, pixels may have depths that do not match a foreground or a background. Such pixels may represent a discontinuity. The systems and techniques may measure discontinuities around boundaries (e.g., edges of objects, which may form a boundary between a foreground and the background) and perform thresholding. Such thresholding may be based on not only depths also based on amplitude information. For example, a standard depth discontinuity may be 1% or 2% based on the depths value itself. Because the systems and techniques may have the amplitude values, the surface may be distant, and the depths discontinuity might be higher than what is supposed to be so the depth can be adjusted.

For example, a current pixel may be surrounded by a three by three or five by five window or neighborhood. System 500B may calculate the difference between the depth of center pixel and the depth of the pixels in the window. System 500B may compare the difference with a discontinuity threshold, which may be referred to as a “jump threshold.” The discontinuity threshold may be based on depths value itself (e.g., a 1% to 2% difference). Additionally or alternatively, the discontinuity threshold may be based on the amplitude. For example, if a pixel is too dark (too distant), system 500B may make it higher (closer) or too bright (too close), will make it lower (more distant). In this way, system 500B adjust the threshold. As another example, system 500B may count values of the window that are within the threshold. If a majority of the window is greater than the threshold, the current pixel may be determined to be invalid.

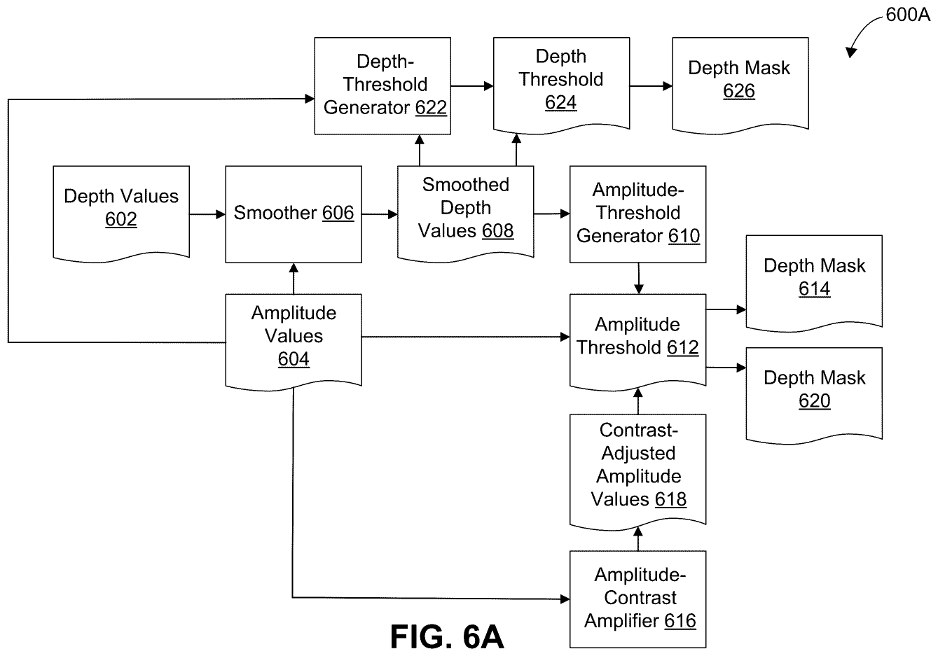

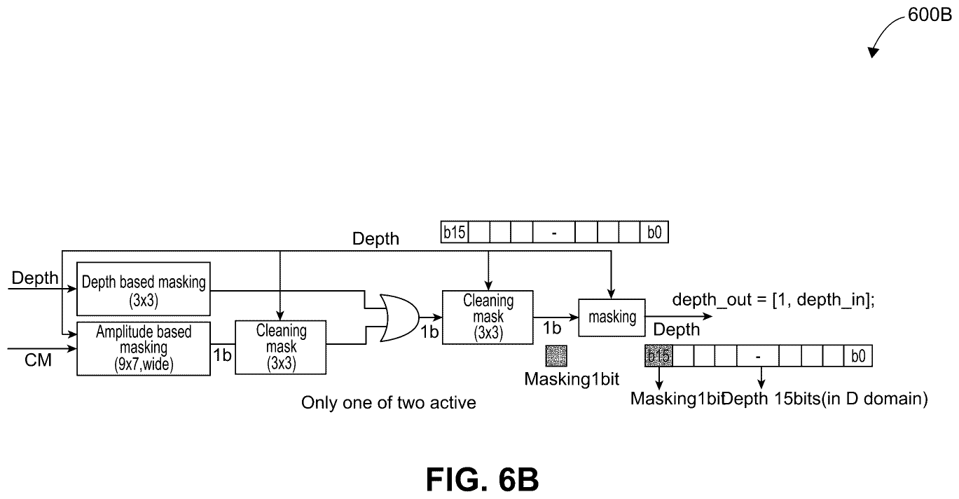

FIG. 6A is a diagram illustrating an example system 600A for enhancing depth values 602 based on amplitude values 604, according to various aspects of the present disclosure. System 600A may include, or perform the processes described with regard to, system 100 of FIG. 1, system 200A of FIG. 2A, system 200B of FIG. 2B, system 300 of FIG. 3, system 400A of FIG. 4A, system 400B of FIG. 4B, system 500A of FIG. 5A, and/or system 500B of FIG. 5B. System 600A is as an example to describe how system 200A, system 200B, system 300, system 400A, and/or system 500A may be used together.

System 600A may obtain depth values 602, which may include a number of discrete depth values. Depth values 602 may be generated by a ToF camera based on timings of ToF signals. Depth values 602 may be the same as, or may be substantially similar to, as depth representation 202 of FIG. 2A, depth representation 302 of FIG. 3, depth representation 402 of FIG. 4A, and/or depth representation 502 of FIG. 5A.

System 600A may obtain amplitude values 604, which may include a number of discrete amplitude values. Amplitude values 604 may be generated by a ToF camera based on amplitudes of ToF signals. Each of amplitude values 604 may correspond to a respective one of depth values 602. For example, each of amplitude values 604 may be based on an amplitude of a ToF signal that was used to determine a corresponding one of depth values 602. Amplitude values 604 may be the same as, or may be substantially similar to, amplitude representation 210 of FIG. 2A, amplitude representation 310 of FIG. 3, amplitude representation 410 of FIG. 4A, and/or amplitude representation 510 of FIG. 5A.

Smoother 606 may be the same as, may be substantially similar to, and/or may perform the same, or substantially the same, operations as system 200A and/or system 200B. For example, smoother 606 may generate smoothed depth values 608 based on depth values 602 and amplitude values 604. Smoothed depth values 608 may be the same as, or may be substantially similar to, smoothed depth representation 228 of FIG. 2A.

Amplitude-threshold generator 610 and the operations of system 600A using amplitude threshold 612 collectively may be the same as, may be substantially similar to, and/or may perform the same, or substantially the same, operations as system 300 of FIG. 3. For example, amplitude-threshold generator 610 may receive amplitude-threshold generator 610 and may generate amplitude threshold 612 based thereon. Further, system 600A may generate depth mask 614 based on amplitude values 604 and amplitude threshold 612. For example, system 600A may generate depth mask 614 based on which of amplitude values 604 satisfy amplitude threshold 612. Amplitude threshold 612 may be the same as, or may be substantially similar to, amplitude threshold 332 of FIG. 3. Depth mask 614 may be the same as, or may be substantially similar to, mask 336 of FIG. 3.

Amplitude-contrast amplifier 616 and the operations of system 600A using contrast-adjusted amplitude values 618 collectively may be the same as, may be substantially similar to, and/or may perform the same, or substantially the same, operations as system 400A of FIG. 4A. For example, amplitude-contrast amplifier 616 may amplify amplitude values 604 to generate contrast-adjusted amplitude values 618. Further, system 600A may generate depth mask 620 based on contrast-adjusted amplitude values 618 and amplitude threshold 612. For example, system 600A may generate depth mask 620 based on which of contrast-adjusted amplitude values 618 satisfy amplitude threshold 612. Contrast-adjusted amplitude values 618 may be the same as, or may be substantially similar to, contrast-amplified amplitude representation 444 of FIG. 4A. Depth mask 620 may be the same as, or may be substantially similar to, mask 448 of FIG. 4A.

Depth-threshold generator 622 and the operations of system 600A using depth threshold 624 collectively may be the same as, may be substantially similar to, and/or may perform the same, or substantially the same, operations as system 500A of FIG. 5A and/or system 500B of FIG. 5B. For example, depth-threshold generator 622 may generate depth threshold 624 based on amplitude values 604 and smoothed depth values 608. Further, system 600A may generate depth mask 626 based on smoothed depth values 608 and depth threshold 624. For example, system 600A may generate depth mask 626 based on which of, or how many of, smoothed depth values 608 satisfy depth threshold 624. Depth threshold 624 may be the same as, or may be substantially similar to, depth threshold 552 of FIG. 5A. Depth mask 626 may be the same as, or may be substantially similar to, mask 556 of FIG. 5A.

Some of the elements of 600A are optional. For example, in some cases, smoother 606 may be omitted. In such cases, depth values 602 may be used in place of smoothed depth values 608 (e.g., depth values 602 may be provided as an input to amplitude-threshold generator 610, depth-threshold generator 622, and/or depth threshold 624 in place of smoothed depth values 608). As another example, in some cases, amplitude-threshold generator 610 may be omitted. In such cases, amplitude threshold 612 may be determined in some other way. Further, in such cases, depth mask 614 may not be determined and may also be omitted. As another example, in some cases, amplitude-contrast amplifier 616 may be omitted. In such cases, contrast-adjusted amplitude values 618 and depth mask 620 may not be generated and may also be omitted. As another example, in some cases, depth-threshold generator 622 may be omitted. In such cases, depth threshold 624 and depth mask 626 may not be generated and may also be omitted.

FIG. 6B is a diagram illustrating an example system 600B for enhancing depth values based on amplitude values, according to various aspects of the present disclosure. System 600B mask different types of artifact pixels based on depth and amplitude (e.g., low confidence pixels, scattering pixels, or flying pixels). System 600B has several components: amplitude-based masking, depth-based masking, and cleaning mask. Depth-based masking and amplitude-based masking may run independently and may run in parallel. Depth-based masking may generate a depth-based mask. Amplitude-based masking may generate an amplitude-based mask. System 200A of FIG. 2A, system 200B of FIG. 2B, system 300 of FIG. 3, system 400A of FIG. 4A, system 400B of FIG. 4B, system 500A of FIG. 5A, and/or system 500B of FIG. 5B may be examples of depth-based masking and/or amplitude-based masking. For example, system 500B of FIG. 5B may be an example of depth-based masking of system 600B and system 400B of FIG. 4B may be an example of amplitude-based masking of FIG. 6B. System 600B includes masks that check the depth discontinuities and masks that use amplitude, confidence, and boosting.

A cleaning mask may be enabled after amplitude-based masking and/or after the depth-based mask and the amplitude-based mask have been combined. The first cleaning activity is focused on the amplitude-based mask. The second cleaning is based on both the amplitude-based mask and the depth-based mask. In some cases, the second cleaning applies after the amplitude mask and the depth mask have been combined. The output of the cleaning can be in any desired format. All masked created and/or used in system 600B may be in binary format. Such one-bit binary masks may be concatenated with most-significant bits (e.g., 15-bits) to create the 16-bits depth output.

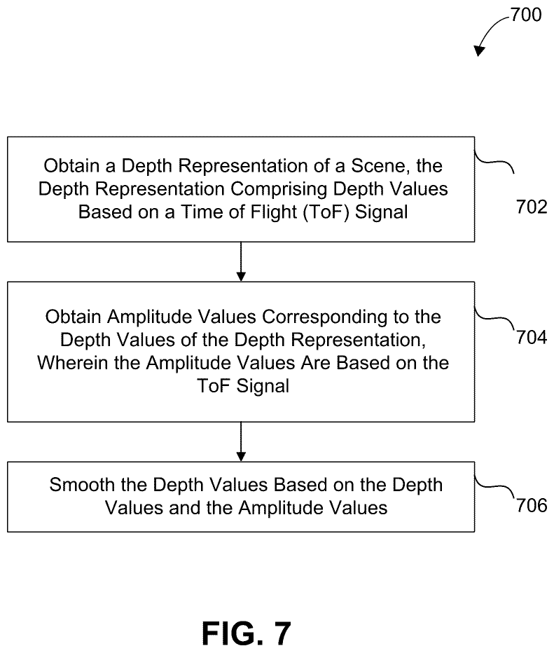

FIG. 7 is a flow diagram illustrating an example process 700 for enhancing depth representations, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The one or more operations of process 700 may be implemented as software components that are executed and run on one or more processors.

At block 702, the computing device (or component thereof) can obtain a depth representation of a scene. The depth representation of the scene includes depth values based on a time of flight (ToF) signal (e.g., an indirect time of flight (iToF) signal). In some cases, the depth representation includes the depth values arranged in a two-dimensional grid as depth pixels. Referring to FIG. 2A as an illustrative example, the depth representation of the scene can include the depth representation 202. Referring to FIG. 2B as another illustrative example, the depth representation of the scene can include the depth information 233 (shown as D[c]).

At block 704, the computing device (or component thereof) can obtain amplitude values corresponding to the depth values of the depth representation. The amplitude values are based on the ToF signal. Referring to FIG. 2A as an illustrative example, the amplitude values can include the amplitude representation 210. Referring to FIG. 2B as another illustrative example, the depth representation of the scene can include the amplitude information 231 (shown as Amp[c]).

At block 706, the computing device (or component thereof) can smooth the depth values based on the depth values and the amplitude values. For instance, referring to FIG. 2A, the system 200A can generate smoothed depth representation 228 based on the depth representation 202 and the amplitude representation 210. In some cases, the computing device (or component thereof) can determine a mask for the depth values based on the depth values and the amplitude values (e.g., to perform the amplitude-based masking techniques described herein).

In some aspects, to smooth the depth values based on the amplitude values, the computing device (or component thereof) can obtain a relationship (e.g., relationship 218 of FIG. 2A, the relationship described with respect to FIG. 2B, etc.) between depths, amplitudes, and noise levels (e.g., noise level 220 of FIG. 2A, the noise described with respect to FIG. 2B, etc.). In some cases, the relationship includes a noise level for each combination of a respective depth of the depths and a respective amplitude of the amplitudes. Additionally or alternatively, in some examples, the relationship includes a lookup table (LUT) including a noise level for each combination of a respective depth of the depths and a respective amplitude of the amplitudes. In some cases, the noise levels of the relationship are based on a standard deviation of noise for each combination of a respective depth of the depths and a respective amplitude of the amplitudes. The computing device (or component thereof) can adaptively filter the depth representation using an adaptive filter. For instance, filter values of the adaptive filter can be determined based on the relationship, the depth values, and the amplitude values. In some aspects, the computing device (or component thereof) can determine filter values of the adaptive filter for each window of a plurality of windows of the depth representation (e.g., window 204 of FIG. 2A, window 232 of FIG. 2B, etc.).

In some aspects, the computing device (or component thereof) can determine a threshold for depth values of a window of plurality of windows based on the relationship, a center depth value (e.g., a center depth value 208 of FIG. 2A, a value of center pixel 230 of FIG. 2B, etc.) of the window, and an amplitude value corresponding to the center depth value. The computing device (or component thereof) can determine filter values of the adaptive filter for the window based on depth values included in the window and the threshold.

In some cases, to determine the filter values of the adaptive filter for a window of the plurality of windows, the computing device (or component thereof) can determine a threshold for depth values of the window based on the relationship, a center depth value of the window, and an amplitude value corresponding to the center depth value. In some examples, the computing device (or component thereof) can determine a filter value of zero corresponding to a depth value of the window that is outside the threshold from the center depth value.

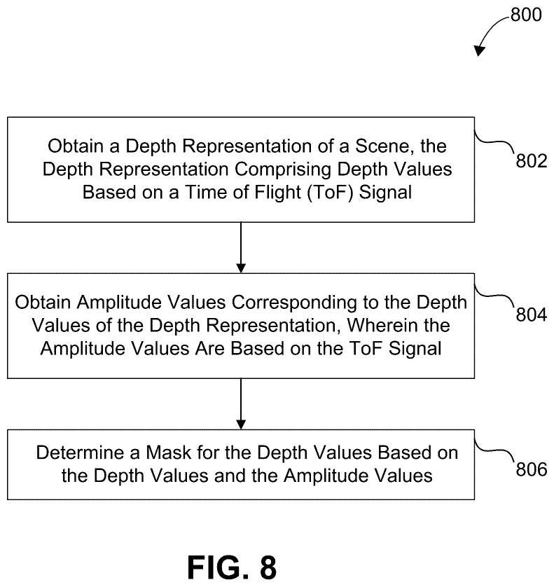

FIG. 8 is a flow diagram illustrating an example process 800 for enhancing depth representations, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At block 802, the computing device (or component thereof) can obtain a depth representation of a scene (e.g., the depth representation 302 of FIG. 3, the depth representation 402 of FIG. 4A, the depth 450 of FIG. 4B, the depth representation 502 of FIG. 5A, the current depth pixel 561 of FIG. 5B, depth values 602 of FIG. 6A, etc.). The depth representation includes depth values based on a time of flight (ToF) signal (e.g., an iToF signal). In some cases, the depth representation includes the depth values arranged in a two-dimensional grid as depth pixels.

At block 804, the computing device (or component thereof) can obtain amplitude values (e.g., the amplitude representation 310 of FIG. 3, the amplitude representation 410 of FIG. 4A, the amplitude 452 of FIG. 4B, the amplitude representation 510 of FIG. 5A, amplitude values 604 of FIG. 6A, etc.) corresponding to the depth values of the depth representation. The amplitude values are based on the ToF signal.

At block 806, the computing device (or component thereof) can determine a mask (e.g., the mask 336 of FIG. 3, the mask 448 of FIG. 4A, the mask described with respect to FIG. 4B, the mask 556 of FIG. 5A, the mask described with respect to FIG. 5B, or other mask described herein) for the depth values based on the depth values and the amplitude values. For instance, the mask is indicative of confidence values for the depth values. In some aspects, the computing device (or component thereof) can smooth the depth values based on the depth values and the amplitude values (e.g., to perform the depth masking techniques described herein).

In some aspects, the computing device (or component thereof) can obtain a relationship (e.g., the relationship 330 of FIG. 3, the relationship 550 of FIG. 5A, the relationship described with respect to FIG. 5B, or other relationship described herein) between depth values and amplitude thresholds. To determine the mask, the computing device (or component thereof) can determine mask values for the mask based on the relationship, the depth values, and the amplitude values (e.g., as described with respect to FIG. 3).

In some cases, the computing device (or component thereof) can obtain a relationship (e.g., the relationship 330 of FIG. 3 or other relationship described herein) between depth values and amplitude thresholds. To determine the mask, the computing device (or component thereof) can determine a respective mask value for each depth value of the depth representation. To determine a mask value for a respective depth value, the computing device (or component thereof) can determine an amplitude threshold for the respective depth value based on the relationship and the respective depth value. The computing device (or component thereof) can determine the respective mask value based on a comparison between an amplitude value corresponding to the respective depth value and the amplitude threshold.

In some aspects, the computing device (or component thereof) can amplify a contrast between the amplitude values to generate contrast-amplified amplitude values (e.g., the contrast-amplified amplitude representation 444 of FIG. 4A). The computing device (or component thereof) can determine the mask (e.g., the mask 448 of FIG. 4A) based on the contrast-amplified amplitude values. In some cases, to amplify the contrast between the amplitude values, the computing device (or component thereof) can apply an unsharp mask to the amplitude values. In some examples, to amplify the contrast between the amplitude values, the computing device (or component thereof) can, within each window of a plurality of windows of the amplitude values, amplify the contrast between respective amplitude values of each window. In some cases, to determine the mask based on the contrast-amplified amplitude values, the computing device (or component thereof) can compare the amplitude values to an amplitude threshold (e.g., amplitude threshold 440 of FIG. 4A) to determine the mask (e.g., the mask 448 of FIG. 4A). In some examples, the computing device (or component thereof) can determine the amplitude threshold based on a relationship between depth values and amplitude thresholds.

In some aspects, the computing device (or component thereof) can obtain a relationship between depths, amplitudes, and noise levels. The computing device (or component thereof) can determine a mask value corresponding to a depth value based on the relationship, the depth value, and an amplitude value corresponding to the depth value (e.g., as described with respect to FIG. 5A and/or FIG. 5B). In some cases, the computing device (or component thereof) can obtain a relationship between depths, amplitudes, and noise levels and can determine a threshold (e.g., depth threshold 552 of FIG. 5A) for a depth value based on the relationship, the depth value, and an amplitude value corresponding to the depth value. The computing device (or component thereof) can determine a mask value corresponding the depth value based on a number of depth values of a window of a plurality of windows of the depth values that are within the threshold from the depth value.

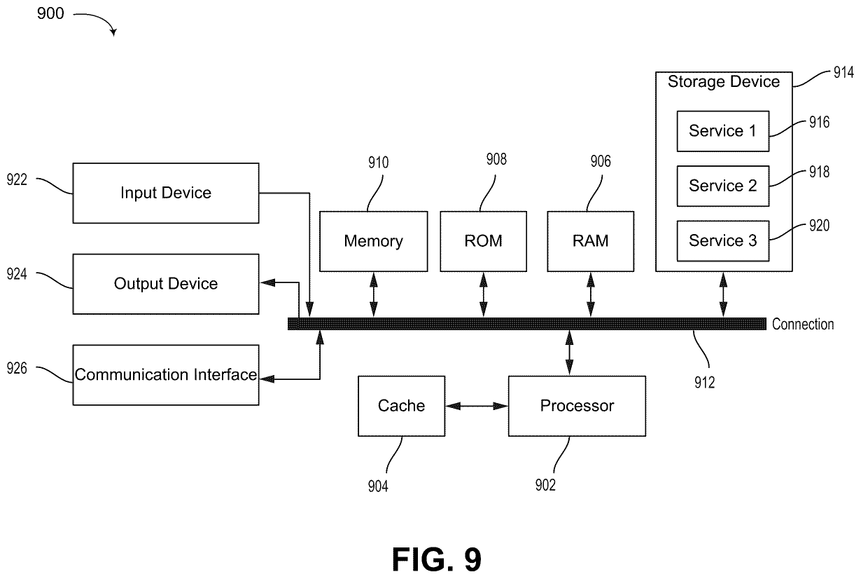

In some examples, as noted previously, the methods described herein (e.g., process 700 of FIG. 7, process 800 of FIG. 8, and/or other methods described herein) can be performed, in whole or in part, by a computing device or apparatus. In one example, one or more of the methods can be performed by system 100 of FIG. 1, system 200A of FIG. 2A, system 200B of FIG. 2B, system 300 of FIG. 3, system 400A of FIG. 4A, system 400B of FIG. 4B, system 500A of FIG. 5A, system 500B of FIG. 5B, system 600A of FIG. 6A system 600B of FIG. 6B, or by another system or device. In another example, one or more of the methods (e.g., process 700 of FIG. 7, process 800 of FIG. 8, and/or other methods described herein) can be performed, in whole or in part, by the computing-device architecture 900 shown in FIG. 9. For instance, a computing device with the computing-device architecture 900 shown in FIG. 9 can include, or be included in, the components of the system 100, system 200A, system 200B, system 300, system 400A, system 500A, system 600A, and/or system 600B and can implement the operations of process 700, process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program including a plurality of instructions executable by one or more processors. The computer-readable or machine-readable storage medium can be non-transitory.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in any or all of system 100 of FIG. 1, system 200A of FIG. 2A, system 200B of FIG. 2B, system 300 of FIG. 3, system 400A of FIG. 4A, system 400B of FIG. 4B, system 500A of FIG. 5A, system 500B of FIG. 5B, system 600A of FIG. 6A, and/or system 600B of FIG. 6B. Additionally, or alternatively, computing-device architecture 900 may be configured to perform process 700 of FIG. 7 and/or process 800 of FIG. 8.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other modules can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software modules are contemplated. Storage device 914 can be connected to the computing device connection 912. In one aspect, a hardware module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“S”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for enhancing depth representations, the apparatus comprising: at least one memory; and at least one processor coupled to the at least one memory and configured to: obtain a depth representation of a scene, the depth representation comprising depth values based on a time of flight (ToF) signal; obtain amplitude values corresponding to the depth values of the depth representation, wherein the amplitude values are based on the ToF signal; and smooth the depth values based on the depth values and the amplitude values.

Aspect 2. The apparatus of Aspect 1, wherein, to smooth the depth values based on the amplitude values, the at least one processor is configured to: obtain a relationship between depths, amplitudes, and noise levels; and adaptively filter the depth representation using an adaptive filter, wherein filter values of the adaptive filter are determined based on the relationship, the depth values, and the amplitude values.

Aspect 3. The apparatus of Aspect 2, wherein the at least one processor is configured to determine filter values of the adaptive filter for each window of a plurality of windows of the depth representation.

Aspect 4. The apparatus of Aspect 3, wherein the at least one processor is configured to: determine a threshold for depth values of a window of plurality of windows based on the relationship, a center depth value of the window, and an amplitude value corresponding to the center depth value; and determine filter values of the adaptive filter for the window based on depth values included in the window and the threshold.

Aspect 5. The apparatus of any one of Aspects 3 or 4, wherein, to determine the filter values of the adaptive filter for a window of the plurality of windows, the at least one processor is configured to: determine a threshold for depth values of the window based on the relationship, a center depth value of the window, and an amplitude value corresponding to the center depth value; and determine a filter value of zero corresponding to a depth value of the window that is outside the threshold from the center depth value.

Aspect 6. The apparatus of any one of Aspects 2 to 5, wherein the relationship comprises a noise level for each combination of a respective depth of the depths and a respective amplitude of the amplitudes.

Aspect 7. The apparatus of any one of Aspects 2 to 6, wherein the relationship comprises a lookup table (LUT) including a noise level for each combination of a respective depth of the depths and a respective amplitude of the amplitudes.

Aspect 8. The apparatus of any one of Aspects 2 to 7, wherein the noise levels of the relationship are based on a standard deviation of noise for each combination of a respective depth of the depths and a respective amplitude of the amplitudes.

Aspect 9. The apparatus of any one of Aspects 1 to 8, wherein the depth representation comprises the depth values arranged in a two-dimensional grid as depth pixels.

Aspect 10. The apparatus of any one of Aspects 1 to 9, wherein the at least one processor is configured to determine a mask for the depth values based on the depth values and the amplitude values.

Aspect 11. The apparatus of any one of Aspects 1 to 10, wherein the ToF signal is an indirect time of flight (iToF) signal.

Aspect 12. A method for enhancing depth representations, the method comprising: obtaining a depth representation of a scene, the depth representation comprising depth values based on a time of flight (ToF) signal; obtaining amplitude values corresponding to the depth values of the depth representation, wherein the amplitude values are based on the ToF signal; and smoothing the depth values based on the depth values and the amplitude values.

Aspect 13. The method of Aspect 12, wherein smoothing the depth values based on the amplitude values comprises: obtaining a relationship between depths, amplitudes, and noise levels; and adaptively filtering the depth representation using an adaptive filter, wherein filter values of the adaptive filter are determined based on the relationship, the depth values, and the amplitude values.

Aspect 14. The method of Aspect 13, further comprising determining filter values of the adaptive filter for each window of a plurality of windows of the depth representation.

Aspect 15. The method of Aspect 14, further comprising: determining a threshold for depth values of a window of plurality of windows based on the relationship, a center depth value of the window, and an amplitude value corresponding to the center depth value; and determining filter values of the adaptive filter for the window based on depth values included in the window and the threshold.

Aspect 16. The method of any one of Aspects 14 or 15, wherein determining the filter values of the adaptive filter for a window of the plurality of windows comprises: determining a threshold for depth values of the window based on the relationship, a center depth value of the window, and an amplitude value corresponding to the center depth value; and determining a filter value of zero corresponding to a depth value of the window that is outside the threshold from the center depth value.

Aspect 17. The method of any one of Aspects 13 to 16, wherein the relationship comprises a noise level for each combination of a respective depth of the depths and a respective amplitude of the amplitudes.

Aspect 18. The method of any one of Aspects 13 to 17, wherein the relationship comprises a lookup table (LUT) including a noise level for each combination of a respective depth of the depths and a respective amplitude of the amplitudes.

Aspect 19. The method of any one of Aspects 13 to 18, wherein the noise levels of the relationship are based on a standard deviation of noise for each combination of a respective depth of the depths and a respective amplitude of the amplitudes.

Aspect 20. The method of any one of Aspects 12 to 19, wherein the depth representation comprises the depth values arranged in a two-dimensional grid as depth pixels.

Aspect 21. The method of any one of Aspects 12 to 20, further comprising determining a mask for the depth values based on the depth values and the amplitude values.

Aspect 22. The method of any one of Aspects 12 to 21, wherein the ToF signal is an indirect time of flight (iToF) signal.

Aspect 23. An apparatus for enhancing depth representations, the apparatus comprising: at least one memory; and at least one processor coupled to the at least one memory and configured to: obtain a depth representation of a scene, the depth representation comprising depth values based on a time of flight (ToF) signal; obtain amplitude values corresponding to the depth values of the depth representation, wherein the amplitude values are based on the ToF signal; and determine a mask for the depth values based on the depth values and the amplitude values.

Aspect 24. The apparatus of Aspect 23, wherein: the at least one processor is configured to obtain a relationship between depth values and amplitude thresholds; and to determine the mask, the at least one processor is configured to determine mask values for the mask based on the relationship, the depth values, and the amplitude values.

Aspect 25. The apparatus of any one of Aspects 23 or 24, wherein: the at least one processor is configured to obtain a relationship between depth values and amplitude thresholds; to determine the mask, the at least one processor is configured to determine a respective mask value for each depth value of the depth representation; and to determine a mask value for a respective depth value, the at least one processor is configured to: determine an amplitude threshold for the respective depth value based on the relationship and the respective depth value; and determine the respective mask value based on a comparison between an amplitude value corresponding to the respective depth value and the amplitude threshold.

Aspect 26. The apparatus of any one of Aspects 23 to 25, wherein the at least one processor is configured to: amplify a contrast between the amplitude values to generate contrast-amplified amplitude values; and determine the mask based on the contrast-amplified amplitude values.

Aspect 27. The apparatus of Aspect 26, wherein, to amplify the contrast between the amplitude values, the at least one processor is configured to apply an unsharp mask to the amplitude values.

Aspect 28. The apparatus of any one of Aspects 26 or 27, wherein, to amplify the contrast between the amplitude values, the at least one processor is configured to, within each window of a plurality of windows of the amplitude values, amplify the contrast between respective amplitude values of each window.

Aspect 29. The apparatus of any one of Aspects 26 to 28, wherein, to determine the mask based on the contrast-amplified amplitude values, the at least one processor is configured to compare the amplitude values to an amplitude threshold to determine the mask.

Aspect 30. The apparatus of Aspect 29, wherein the at least one processor is configured to determine the amplitude threshold based on a relationship between depth values and amplitude thresholds.

Aspect 31. The apparatus of any one of Aspects 23 to 30, wherein the at least one processor is configured to: obtain a relationship between depths, amplitudes, and noise levels; and determine a mask value corresponding to a depth value based on the relationship, the depth value, and an amplitude value corresponding to the depth value.

Aspect 32. The apparatus of any one of Aspects 23 to 31, wherein the at least one processor is configured to: obtain a relationship between depths, amplitudes, and noise levels; determine a threshold for a depth value based on the relationship, the depth value, and an amplitude value corresponding to the depth value; and determining a mask value corresponding the depth value based on a number of depth values of a window of a plurality of windows of the depth values that are within the threshold from the depth value.

Aspect 33. The apparatus of any one of Aspects 23 to 32, wherein the mask is indicative of confidence values for the depth values.

Aspect 34. The apparatus of any one of Aspects 23 to 33, wherein the depth representation comprises the depth values arranged in a two-dimensional grid as depth pixels.

Aspect 35. The apparatus of any one of Aspects 23 to 34, wherein the at least one processor is configured to smooth the depth values based on the depth values and the amplitude values.

Aspect 36. The apparatus of any one of Aspects 23 to 35, wherein the ToF signal is an indirect time of flight (iToF) signal.

Aspect 37. A method for enhancing depth representations, the method comprising: obtaining a depth representation of a scene, the depth representation comprising depth values based on a time of flight (ToF) signal; obtaining amplitude values corresponding to the depth values of the depth representation, wherein the amplitude values are based on the ToF signal; and determining a mask for the depth values based on the depth values and the amplitude values.

Aspect 38. The method of Aspect 37, further comprising obtaining a relationship between depth values and amplitude thresholds; wherein determining the mask comprises determining mask values for the mask based on the relationship, the depth values, and the amplitude values.

Aspect 39. The method of any one of Aspects 37 or 38, further comprising obtaining a relationship between depth values and amplitude thresholds; wherein determining the mask comprises determining a respective mask value for each depth value of the depth representation; and wherein determining a mask value for a respective depth value comprises: determining an amplitude threshold for the respective depth value based on the relationship and the respective depth value; and determining the respective mask value based on a comparison between an amplitude value corresponding to the respective depth value and the amplitude threshold.

Aspect 40. The method of any one of Aspects 37 to 39, further comprising: amplifying a contrast between the amplitude values to generate contrast-amplified amplitude values; and determining the mask based on the contrast-amplified amplitude values.

Aspect 41. The method of Aspect 40, wherein amplifying the contrast between the amplitude values comprises applying an unsharp mask to the amplitude values.

Aspect 42. The method of any one of Aspects 40 or 41, wherein amplifying the contrast between the amplitude values comprises, within each window of a plurality of windows of the amplitude values, amplifying the contrast between respective amplitude values of each window.

Aspect 43. The method of any one of Aspects 40 to 42, wherein determining the mask based on the contrast-amplified amplitude values comprises comparing the amplitude values to an amplitude threshold to determine the mask.

Aspect 44. The method of Aspect 43, further comprising determining the amplitude threshold based on a relationship between depth values and amplitude thresholds.

Aspect 45. The method of any one of Aspects 37 to 44, further comprising: obtaining a relationship between depths, amplitudes, and noise levels; and determining a mask value corresponding to a depth value based on the relationship, the depth value, and an amplitude value corresponding to the depth value.

Aspect 46. The method of any one of Aspects 37 to 45, further comprising: obtaining a relationship between depths, amplitudes, and noise levels; determining a threshold for a depth value based on the relationship, the depth value, and an amplitude value corresponding to the depth value; and determining a mask value corresponding the depth value based on a number of depth values of a window of a plurality of windows of the depth values that are within the threshold from the depth value.

Aspect 47. The method of any one of Aspects 37 to 46, wherein the mask is indicative of confidence values for the depth values.

Aspect 48. The method of any one of Aspects 37 to 47, wherein the depth representation comprises the depth values arranged in a two-dimensional grid as depth pixels.

Aspect 49. The method of any one of Aspects 37 to 48, further comprising smoothing the depth values based on the depth values and the amplitude values.

Aspect 50. The method of any one of Aspects 37 to 49, wherein the ToF signal is an indirect time of flight (iToF) signal.

Aspect 51. A non-transitory computer-readable storage medium comprising instructions stored thereon which, when executed by at least one processor, causes the at least one processor to perform operations according to any one of Aspects 12 to 22.

Aspect 52. An apparatus for enhancing depth representations, comprising one or more means for performing operations according to any one of Aspects 12 to 22.

Aspect 53. A non-transitory computer-readable storage medium comprising instructions stored thereon which, when executed by at least one processor, causes the at least one processor to perform operations according to any one of Aspects 37 to 50.

Aspect 54. An apparatus for enhancing depth representations, comprising one or more means for performing operations according to any one of Aspects 37 to 50.

What is claimed is:

1. An apparatus for enhancing depth representations, the apparatus comprising:
at least one memory; and
at least one processor coupled to the at least one memory and configured to:
obtain a depth representation of a scene, the depth representation comprising depth values based on a time of flight (ToF) signal;
obtain amplitude values corresponding to the depth values of the depth representation, wherein the amplitude values are based on the ToF signal; and
smooth the depth values based on the depth values and the amplitude values.

2. The apparatus of claim 1, wherein, to smooth the depth values based on the amplitude values, the at least one processor is configured to:
obtain a relationship between depths, amplitudes, and noise levels; and
adaptively filter the depth representation using an adaptive filter, wherein filter values of the adaptive filter are determined based on the relationship, the depth values, and the amplitude values.

3. The apparatus of claim 2, wherein the at least one processor is configured to determine filter values of the adaptive filter for each window of a plurality of windows of the depth representation.

4. The apparatus of claim 3, wherein the at least one processor is configured to:
determine a threshold for depth values of a window of plurality of windows based on the relationship, a center depth value of the window, and an amplitude value corresponding to the center depth value; and
determine filter values of the adaptive filter for the window based on depth values included in the window and the threshold.

5. The apparatus of claim 3, wherein, to determine the filter values of the adaptive filter for a window of the plurality of windows, the at least one processor is configured to:
determine a threshold for depth values of the window based on the relationship, a center depth value of the window, and an amplitude value corresponding to the center depth value; and
determine a filter value of zero corresponding to a depth value of the window that is outside the threshold from the center depth value.

6. The apparatus of claim 2, wherein the relationship comprises a noise level for each combination of a respective depth of the depths and a respective amplitude of the amplitudes.

7. The apparatus of claim 2, wherein the relationship comprises a lookup table (LUT) including a noise level for each combination of a respective depth of the depths and a respective amplitude of the amplitudes.

8. The apparatus of claim 2, wherein the noise levels of the relationship are based on a standard deviation of noise for each combination of a respective depth of the depths and a respective amplitude of the amplitudes.

9. The apparatus of claim 1, wherein the depth representation comprises the depth values arranged in a two-dimensional grid as depth pixels.

10. The apparatus of claim 1, wherein the at least one processor is configured to determine a mask for the depth values based on the depth values and the amplitude values.

11. The apparatus of claim 1, wherein the ToF signal is an indirect time of flight (iToF) signal.

12. A method for enhancing depth representations, the method comprising:
obtaining a depth representation of a scene, the depth representation comprising depth values based on a time of flight (ToF) signal;
obtaining amplitude values corresponding to the depth values of the depth representation, wherein the amplitude values are based on the ToF signal; and
smoothing the depth values based on the depth values and the amplitude values.

13. The method of claim 12, wherein smoothing the depth values based on the amplitude values comprises:
obtaining a relationship between depths, amplitudes, and noise levels; and
adaptively filtering the depth representation using an adaptive filter, wherein filter values of the adaptive filter are determined based on the relationship, the depth values, and the amplitude values.

14. The method of claim 13, further comprising determining filter values of the adaptive filter for each window of a plurality of windows of the depth representation.

15. The method of claim 14, further comprising:
determining a threshold for depth values of a window of plurality of windows based on the relationship, a center depth value of the window, and an amplitude value corresponding to the center depth value; and
determining filter values of the adaptive filter for the window based on depth values included in the window and the threshold.

16. The method of claim 14, wherein determining the filter values of the adaptive filter for a window of the plurality of windows comprises:
determining a threshold for depth values of the window based on the relationship, a center depth value of the window, and an amplitude value corresponding to the center depth value; and
determining a filter value of zero corresponding to a depth value of the window that is outside the threshold from the center depth value.

17. The method of claim 13, wherein the relationship comprises a noise level for each combination of a respective depth of the depths and a respective amplitude of the amplitudes.

18. The method of claim 13, wherein the relationship comprises a lookup table (LUT) including a noise level for each combination of a respective depth of the depths and a respective amplitude of the amplitudes.

19. The method of claim 13, wherein the noise levels of the relationship are based on a standard deviation of noise for each combination of a respective depth of the depths and a respective amplitude of the amplitudes.

20. The method of claim 12, wherein the depth representation comprises the depth values arranged in a two-dimensional grid as depth pixels.

21. The method of claim 12, further comprising determining a mask for the depth values based on the depth values and the amplitude values.

22. The method of claim 12, wherein the ToF signal is an indirect time of flight (iToF) signal.
